(19) United States
(12) Patent Application Publication
(10) Pub. No.: US 2007/0218385 A1
(43) Pub. Date: Sep. 20, 2007

(54) TONER, AND IMAGE FORMING APPARATUS AND PROCESS CARTRIDGE USING THE TONER

(76) Inventors: Satoshi Kojima, Numazu-shi (JP); Toyoshi Sawada, Yokohama-shi (JP); Tsuneyasu Nagatomo, Numazu-shi (JP); Takuya Seshita, Hiratsuka-shi (JP); Tomomi Suzuki, Numazu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/687,875

(22) Filed: Mar. 19, 2007

(30) Foreign Application Priority Data
Mar. 17, 2006 (JP) 2006-073757

(51) Int. Cl. G03G 9/08; G03G 9/00

(52) U.S. Cl. 430/108.1; 430/110.3; 430/137.15; 430/108.7

(57) ABSTRACT

A toner is provided including a binder resin and a colorant, wherein the toner has an average shape factor SF-1 of from 130 to 160, and includes toner particles having a shape factor SF-1 of from 100 to 115 in an amount of not greater than 2% by number, and wherein the toner is prepared by a wet granulation method, along with an image forming apparatus and process cartridge using the toner.

### BACKGROUND OF THE INVENTION

1. Field of the Invention

The present invention relates to a toner for use in electrophotography. In addition, the present invention also relates to an image forming apparatus and a process cartridge using the toner.

2. Discussion of the Background

In an image forming apparatus using electrophotography, an image is typically formed as follows:

(1) uniformly charging the surface of an image bearing member (i.e., charging process);

(2) writing an electrostatic latent image on the image bearing member (i.e., irradiating process);

(3) forming a toner image with a friction-charged toner on the image bearing member (i.e., developing process);

(4) transferring the toner image onto a printing paper directly or indirectly via an intermediate transfer member (i.e., transfer process); and

(5) fixing the toner image to the printing paper (i.e., fixing process).

Toner particles remaining on the image bearing member after the transfer process are removed therefrom to prepare for the next image forming operation (i.e., cleaning process).

Developers for use in electrophotography are classified into a two-component developer consisting essentially of a toner and a carrier, and a one-component developer consisting essentially of a toner. The toner is typically prepared by a pulverization method in which a binder resin, a colorant, a charge controlling agent, a release agent, etc., are melt-kneaded, and then the melt-kneaded mixture is subjected to cooling, pulverization, and classification. In this method, it is difficult to control the particle diameter and the shape of the resultant toner.

In attempting to solve this problem of the pulverization method, polymerization methods such as an emulsion aggregation method and a dissolution suspension method have been proposed and widely used recently.

In order to respond to a recent demand for high quality images, particularly for high resolution full-color images, toners have been modified to have a smaller particle diameter and a narrower particle diameter distribution. When a toner has a broad particle diameter distribution, ultrafine toner particles tend to contaminate a developing roller, a charging roller, a charging blade, a photoreceptor, a carrier, etc., and tend to cause toner scattering. Therefore, high quality and highly reliable images cannot be obtained with such a toner. In contrast, when a toner has a narrow particle diameter distribution, each of the toner particles behaves identically in the developing process, and therefore the microdot reproducibility of the resultant image improves.

On the other hand, the toner having a narrow particle diameter distribution has poor cleanability. It is difficult to stably remove toner particles having the uniform small particle diameter from the image bearing member using a cleaning blade. In attempting to improve cleanability of such a toner, various attempts to modify the toner have been proposed. For example, a method in which a spherical toner is modified to have an irregular shape is proposed. When a toner has an irregular shape, the fluidity thereof decreases. Thereby, the toner can be easily prevented from passing through the cleaning blade. However, if a toner has an irregular shape too far from a sphere, the toner cannot behave stably in the developing process, and therefore microdot reproducibility decreases. Since transferability and cleanability of a toner depends on the shape thereof, the toner is required to have an optimal shape.

Published unexamined Japanese patent application No. (hereinafter referred to as JP-A) 2005-215298 discloses a toner having a shape property such that the toner has an average shape factor SF-1 of not less than 110 and satisfies the following equation:
2.0≦A/B≦7.0
wherein A represents a ratio (%) of a number of toner particles having a shape factor SF-1 within a range of 5 smaller and larger of the maximum SF-1 value in the number distribution to a total number of the toner particles, and B represents a ratio (%) of a number of toner particles having a shape factor SF-1 of not less than 150 to a total number of the toner particles.

But no mention is made of toner particles having a smaller SF-1, which may have an influence on cleanability of the toner.

JP-A 2000-267331 discloses a toner having an average shape factor SF-1 of from 125 to 140, and including toner particles having a shape factor SF-1 of not greater than 120 in an amount of not greater than 20% by number and toner particles having a shape factor SF-1 of not less than 150 in an amount of not greater than 20% by number. When the toner includes toner particles having a shape factor SF-1 of not greater than 120 in an amount of not greater than 20% by number, toner particles having a smaller shape factor SF-1 are not excluded from the toner, and therefore the toner has insufficient cleanability. As a result, ultrafine toner particles tend to contaminate a developing device, a photoreceptor, an intermediate transfer medium, etc.

### SUMMARY OF THE INVENTION

Accordingly, an object of the present invention is to provide a toner which can produce high quality images having good microdot reproducibility.

Another object of the present invention is to provide an image forming apparatus and a process cartridge which can remove toner particles from the image bearing member without deteriorating a cleaning blade, even if the toner particles are spherical.

These and other objects of the present invention, either individually or in combinations thereof, as hereinafter will become more readily apparent can be attained by a toner comprising:

a binder resin; and

a colorant,

wherein the toner has an average shape factor SF-1 of from 130 to 160, and includes toner particles having a shape factor SF-1 of from 100 to 115 in an amount of not greater than 2% by number, and

wherein the toner is prepared by a wet granulation method; and an image forming apparatus and a process cartridge using the toner.

### BRIEF DESCRIPTION OF THE DRAWINGS

These and other objects, features and advantages of the present invention will become apparent upon consideration of the following description of the preferred embodiments of the present invention taken in conjunction with the accompanying drawings, wherein:

FIG. 1 is a schematic view for explaining how to determine the shape factor SF-1;

FIGS. 2A-2C are schematic views illustrating a typical particle of the toner of the present invention;

FIG. 3 is a schematic view illustrating an embodiment of the image forming apparatus of the present invention;

FIG. 4 is a schematic view illustrating another embodiment of the image forming apparatus of the present invention;

FIG. 5 is a schematic view illustrating an embodiment of the image forming unit included in the image forming apparatus illustrated in FIG. 4;

FIG. 6 is a schematic view illustrating a printing chart for use in the evaluation of the toner of the present invention; and

FIG. 7 is a graph illustrating the relationship between the shape factor SF-1 and the cleanability of the toner of the present invention.

### DETAILED DESCRIPTION OF THE INVENTION

Generally, the present invention provides a toner having an average shape factor SF-1 of from 130 to 160, and including toner particles having a shape factor SF-1 of from 100 to 115 in an amount of not greater than 2% by number, which is prepared by a wet granulation method.

When the average SF-1 is too small, the toner tends to pass through cleaning means, resulting in deterioration of cleanability of the toner. When the average SF-1 is too large, the toner shape is too far from a sphere, resulting in deterioration of transferability of the toner. As a result, an abnormal image having a vermiculate image defect tends to be produced. The toner preferably has an average shape factor SF-1 of from 130 to 150.

When the toner includes too large an amount of toner particles having a shape factor SF-1 of from 100 to 115, cleanability of the toner deteriorates, and therefore the toner tends to contaminate the machine components and the resultant image has low reliability. When the toner includes toner particles having a shape factor SF-1 of from 100 to 115 in an amount of not greater than 2% by number, preferably not greater than 0.5% by number, the toner has good cleanability.

The above toner can be well removed even if a cleaning blade is used as the cleaning means.

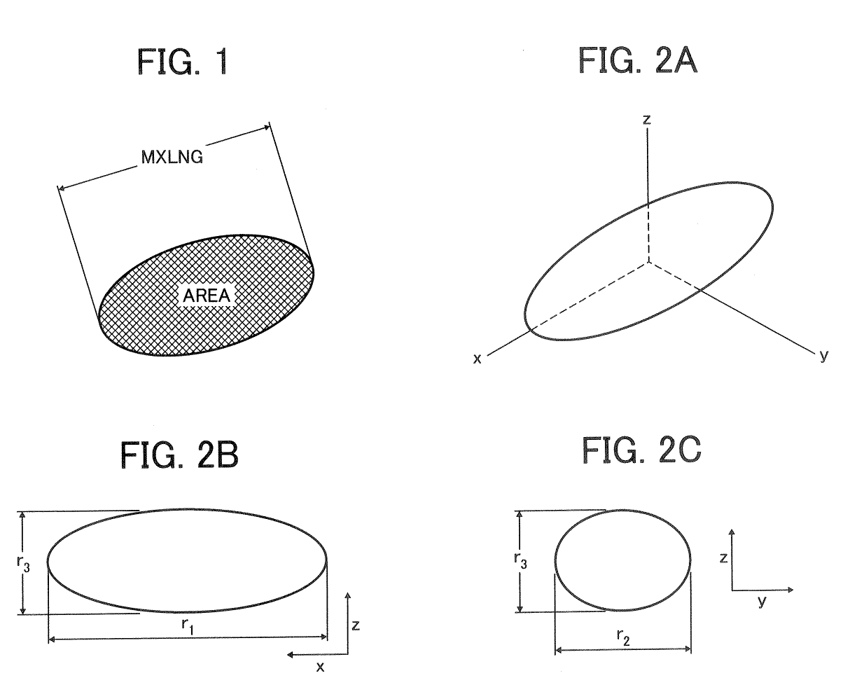

FIG. 1 is a schematic view for explaining how to determine the shape factor SF-1.

As illustrated in FIG. 1, the shape factor SF-1 represents the degree of the roundness of a toner particle, and is defined by the following equation (1):
SF-1={(MXLNG)²/(AREA)}×(100π/4) (1)
wherein MXLNG represents a diameter of the circle circumscribing the image of a toner particle, which image is obtained by observing the toner particle with a microscope; and AREA represents the area of the image.

When the SF-1 is 100, the toner particle has a true spherical form. When the SF-1 is larger than 100, the toner particles have irregular forms.

The shape factor SF-1 is preferably determined by the following method, but the method is not limited thereto:

(1) particles of a toner are photographed using a scanning electron microscope (FE-SEM S-4200 manufactured by Hitachi Ltd.); and

(2) photographic images of 300 randomly selected toner particles are analyzed using an image analyzer (LUZEX AP manufactured by Nicolet Corp.) to determine the SF-1.

When the toner particles have spherical forms, each of the toner particles contacts another toner particle and the photoreceptor at one point. Therefore, the adhesion of the toner particle to the other toner particle and the photoreceptor decreases, resulting in increase of fluidity and transferability of the toner. When the toner has too large a SF-1, transferability deteriorates.

The toner of the present invention is preferably prepared by a wet granulation method. For example, a method including the following steps is preferably used:

dissolving or dispersing toner constituents comprising a binder resin, a prepolymer consisting essentially of a modified polyester, a compound capable of elongating or crosslinking with the prepolymer, a colorant, a release agent, and a modified laminar inorganic mineral in which an interlaminar ion is partially substituted with an organic ion, in an organic solvent, to prepare a toner constituent mixture liquid;

dispersing the toner constituent mixture liquid in an aqueous medium while subjecting the prepolymer to a crosslinking or an elongation reaction with the compound, to prepare a dispersion comprising toner particles; and

removing the organic solvent from the dispersion,

wherein the toner constituent mixture has a Casson yield value of from 1 to 100 Pa at 25° C.

In particular, a polyester is preferably used as the binder resin, and a polyester prepolymer having a functional group containing a nitrogen atom is preferably used as the prepolymer consisting essentially of a modified polyester.

(Polyester)

A polyester is formed from polycondensation reaction between a polyol and a polycarboxylic acid.

As the polyol (PO), diols (DIO), polyols (TO) having three or more valences, and mixtures thereof can be used. Among these, diols (DIO) alone, and mixtures in which a diol (DIO) is mixed with a small amount of a polyol (TO) having three or more valences are preferably used.

Specific examples of the diols (DIO) include, but are not limited to, alkylene glycols (e.g., ethylene glycol, 1,2-propylene glycol, 1,3-propylene glycol, 1,4-butanediol, 1,6-hexanediol), alkylene ether glycols (e.g., diethylene glycol, triethylene glycol, dipropylene glycol, polyethylene glycol, polypropylene glycol, polytetramethylene ether glycol), alicyclicdiols (e.g., 1,4-cyclohexanedimethanol, hydrogenated bisphenol A), bisphenols (e.g., bisphenol A, bisphenol F, bisphenol S), and adducts of the alicyclic diols with an alkylene oxide (e.g., ethylene oxide, propylene oxide, butylene oxide), and adducts of the bisphenols with an alkylene oxide (e.g., ethylene oxide, propylene oxide, butylene oxide). Among these, alkylene glycols having 2 to 12 carbon atoms and adducts of bisphenols with an alkylene oxide are preferably used, and adducts of bisphenols with an alkylene oxide alone and mixtures thereof are more preferably used.

Specific examples of the polyols (TO) having three or more valences include, but are not limited to, multivalent aliphatic alcohols having three or more valences (e.g., glycerin, trimethylolethane, trimethylolpropane, pentaerythritol, sorbitol), polyphenols having three or more valences (e.g., trisphenol PA, phenol novolac, cresol novolac), and adducts of the polyphenols having three or more valences with an alkylene oxide.

As the polycarboxylic acid (PC), dicarboxylic acids (DIC), polycarboxylic acids (TC) having three or more valences, and mixtures thereof can be used. Among these, dicarboxylic acids (DIC) alone, and mixtures in which a dicarboxylic acid (DIC) is mixed with a small amount of a polycarboxylic acid (TC) having three or more valences are preferably used.

Specific examples of the dicarboxylic acids (DIC) include, but are not limited to, alkylene dicarboxylic acids (e.g., succinic acid, adipic acid, sebacic acid), alkenylene dicarboxylic acids (e.g., maleic acid, fumaric acid), and aromatic dicarboxylic acids (e.g., phthalic acid, isophthalic acid, terephthalic acid, naphthalene dicarboxylic acid). Among these, alkenylene dicarboxylic acids having 4 to 20 carbon atoms and aromatic dicarboxylic acids having 8 to 20 carbon atoms are preferably used.

Specific examples of the polycarboxylic acid (TC) having three or more valences include, but are not limited to, aromatic polycarboxylic acids having 9 to 20 carbon atoms (e.g., trimellitic acid, pyromellitic acid).

As the polycarboxylic acid (PC), acid anhydrides and lower alkyl esters (e.g., methyl esters, ethyl esters, isopropyl esters) of dicarboxylic acids (DIC), polycarboxylic acids (TC) having three or more valences, and mixtures thereof, can also be used.

A polyol (PO) and a polycarboxylic acid (PC) are mixed so that the equivalent ratio ([OH]/[COOH]) between a hydroxyl group [OH] and a carboxylic group [COOH] is typically from 2/1 to 1/1, preferably from 1.5/1 to 1/1, and more preferably from 1.3/1 to 1.02/1.

A polyol (PO) and a polycarboxylic acid (PC) are subjected to a polycondensation reaction by heating at a temperature of from 150 to 280° C. in the presence of a known catalyst, such as tetrabutoxy titanate and dibutyltinoxide. The water generated by the reaction is removed, under a reduced pressure if desired, to prepare a polyester having a hydroxyl group. The polyester preferably has a hydroxyl value of not less than 5, and typically has an acid value of from 1 to 30, and preferably from 5 to 20. When the polyester has an appropriate acid value, the resultant toner tends to be negatively charged. In addition, such a toner has good affinity to a printing paper, resulting in improvement of low-temperature fixability of the resultant toner. When the acid value is too large, charging stability, particularly environmental stability, of the resultant toner deteriorates.

The polyester typically has a weight average molecular weight of from 10,000 to 400,000, and preferably from 20,000 to 200,000. When the weight average molecular weight is too small, hot offset resistance of the resultant toner deteriorates. When the weight average molecular weight is too large, low-temperature fixability of the resultant toner deteriorates.

As the prepolymer consisting essentially of a modified polyester, a polyester prepolymer having a functional group containing a nitrogen atom is preferably used. As the polyester prepolymer having a functional group containing a nitrogen atom, a polyester prepolymer (A) having an isocyanate group is preferred, which is prepared by reacting a carboxyl group or a hydroxyl group present on the end of a polyester, with a polyisocyanate (PIC). In this case, an amine (B) is preferably used as the compound capable of elongating or crosslinking with the prepolymer. By elongating or crosslinking the polyester prepolymer (A) having an isocyanate group with an amine (B), a urea-modified polyester can be prepared.

Specific examples of the polyisocyanates (PIC) include, but are not limited to, aliphatic polyisocyanates (e.g. tetramethylene diisocyanate, hexamethylene diisocyanate, 2,6-diisocyanatemethyl caproate), alicyclic polyisocyanates (e.g., isophorone diisocyanate, cyclohexylmethane diisocyanate), aromatic diisocyanates (e.g., tolylene diisocyanate, diphenylmethane diisocyanate), aromatic aliphatic diisocyanates (e.g., α,α,α′,α′-tetramethylxylylene diisocyanate), isocyanurates, and the above-mentioned polyisocyanates blocked with phenol derivatives, oxime, caprolactam, etc. These can be used alone or in combination.

A polyisocyanate (PIC) is mixed with a polyester having a hydroxyl group so that the equivalent ratio ([NCO]/[OH]) of isocyanate group [NCO] to hydroxyl group [OH] is typically from 5/1 to 1/1, preferably from 4/1 to 1.2/1, and more preferably from 2.5/1 to 1.5/1. When the ratio [NCO]/[OH] is too large, low temperature fixability of the resultant toner deteriorates. When the ratio [NCO]/[OH] is too small, hot offset resistance of the resultant toner deteriorates.

The polyester prepolymer (A) having an isocyanate group preferably includes polyisocyanate (PIC) units in an amount of from 0.5 to 40% by weight, preferably from 1 to 30% by weight, and more preferably from 2 to 20% by weight. When the content is too small, hot offset resistance of the resultant toner deteriorates and the toner cannot have a good combination of thermostable preservability and low-temperature fixability. When the content is too large, low-temperature fixability of the resultant toner deteriorates.

The average number of isocyanate groups included in a molecule of the polyester prepolymer (A) is typically 1 or more, preferably from 1. 5 to 3, and more preferably from 1.8 to 2.5. When the number of isocyanate groups is less than 1 per molecule, the molecular weight of the urea-modified polyester decreases and hot offset resistance of the resultant toner deteriorates.

Specific examples of the amines (B) include, but are not limited to, diamines (B1), polyamines (B2) having three or more amino groups, amino alcohols (B3), amino mercaptans (B4), amino acids (B5), and blocked amines (B6) in which the amino groups in the amines (B1) to (B5) are blocked.

Specific examples of the diamines (B1) include, but are not limited to, aromatic diamines (e.g., phenylene diamine, diethyltoluene diamine, 4,4′-diaminodiphenyl methane), alicyclic diamines (e.g., 4,4′-diamino-3,3′-dimethyldicyclohexyl methane, diamine cyclohexane, isophoronediamine), and aliphatic diamines (e.g., ethylene diamine, tetramethylene diamine, hexamethylene diamine). Specific examples of the polyamines (B2) having three or more amino groups include, but are not limited to, diethylene triamine, and triethylene tetramine. Specific examples of the amino alcohols (B3) include, but are not limited to, ethanolamine and hydroxyethyl aniline. Specific examples of the amino mercaptan (B4) include, but are not limited to, aminoethyl mercaptan and aminopropyl mercaptan. Specific examples of the amino acids (B5) include, but are not limited to, amino propionic acid and amino caproic acid. Specific examples of the blocked amines (B6) include, but are not limited to, ketimine compounds which are prepared by reacting one of the amines (B1) to (B5) with a ketone such as acetone, methyl ethyl ketone and methyl isobutyl ketone, and oxazoline compounds. Among these, diamines (B1) alone, and mixtures in which a diamine (B1) is mixed with a small amount of a polyamine (B2) having three or more valences are preferably used.

An amine (B) is mixed with the polyester prepolymer (A) having an isocyanate group so that the equivalent ratio ([NCO]/[NHx]) of isocyanate group [NCO] to amino group [NHx] is typically from 1/2 to 2/1, preferably from 1.5/1 to 1/1.5, and more preferably from 1.2/1 to 1/1.2. When the ratio [NCO]/[NHx] is too large or too small, the molecular weight of the urea-modified polyester is too small, resulting in deterioration of hot offset resistance of the resultant toner.

The urea-modified polyester may include a urethane bond in combination with a urea bond. The molar ratio (urea/urethane) of the urea bond to the urethane bond is typically from 100/0 to 10/90, preferably from 80/20 to 20/80, and more preferably from 60/40 to 30/70. When the molar ratio is too small, hot offset resistance of the resultant toner deteriorates.

A urea-modified polyester can be prepared by a one shot method, etc. In particular, a polyol (PO) and a polycarboxylic acid (PC) are subjected to a polycondensation reaction by heating at a temperature of from 150 to 280° C. in the presence of a known catalyst, such as tetrabutoxy titanate and dibutyltin oxide. The water generated by the reaction is removed, under a reduced pressure if desired, to prepare a polyester having a hydroxyl group. A polyisocyanate (PIC) is reacted with the polyester having a hydroxyl group at a temperature of from 40 to 140° C. to prepare a polyester prepolymer (A) having an isocyanate group. Further, an amine (B) is reacted with the polyester prepolymer (A) having an isocyanate group at a temperature of from 0 to 140° C. to prepare a urea-modified polyester.

When a polyisocyanate (PIC) is reacted with a polyester, or a polyester prepolymer (A) is reacted with an amine (B), a solvent can be optionally used. Specific examples of the solvents include, but are not limited to, solvents which are unreactive with the polyisocyanate (PIC) such as aromatic solvents (e.g., toluene, xylene), ketones (e.g., acetone, methyl ethyl ketone, methyl isobutyl ketone), esters (e.g., ethyl acetate), amides (e.g., dimethylformamide, dimethylacetamide), and ethers (e.g., tetrahydrofuran).

When a polyester prepolymer (A) is reacted with an amine (B), a molecular weight control agent can optionally be used to control the molecular weight of the resultant urea-modified polyester. Specific examples of the molecular weight control agent include, but are not limited to, monoamines (e.g., diethyl amine, dibutyl amine, butyl amine, lauryl amine), and blocked amines thereof (e.g., ketimine compounds).

The urea-modified polyester typically has a weight average molecular weight of not less than 10,000, preferably from 20, 000 to 10,000,000, and more preferably from 30,000 to 1,000,000. When the weight average molecular weight is too small, hot offset resistance of the resultant toner deteriorates. The number average molecular weight of the urea-modified polyester is not particularly limited when the above-mentioned unmodified polyester is used in combination. Namely, the weight average molecular weight of the urea-modified polyester has priority over the number average molecular weight thereof. However, when the urea-modified polyester resin is used alone, the number average molecular weight is typically from 2,000 to 15,000, preferably from2,000 to 10,000, and more preferably from2,000 to 8,000. When the number average molecular weight is too large, low-temperature fixability of the resultant toner deteriorates, and in addition, glossiness of full color images deteriorates.

It is preferable that the urea-modified polyester and the unmodified polyester are used in combination, because low-temperature fixability of the resultant toner and glossiness of the resultant full color images improve thereby. The unmodified polyester may include a polyester modified with a bond except for a urea bond (i.e. other modifications may be present other than the presence of urea bond).

It is preferable that the unmodified polyester and the urea-modified polyester are partially soluble with each other to improve low temperature fixability and hot offset resistance of the resultant toner. Therefore, the unmodified polyester and the urea-modified polyester preferably have similar structures.

The weight ratio of the unmodified polyester to the urea-modified polyester is typically from 20/80 to 95/5, preferably from 70/30 to 95/5, more preferably from 75/25 to 95/5, and even more preferably from 80/20 to 93/7. When the weight ratio of the urea-modified polyester resin is too small, the resultant toner has poor hot offset resistance, thermostable preservability and low temperature fixability.

The resultant binder resin including the unmodified polyester and the urea-modified polyester typically has a glass transition temperature (Tg) of from 45 to 65° C., and preferably from 45 to 60° C. When the Tg is too small, thermal resistance of the resultant toner deteriorates. When the Tg is too large, low-temperature fixability of the resultant toner deteriorates.

Since the urea-modified polyester tends to be present at the surface of the resultant toner of the present invention, the toner of the present invention has good thermostable preservability even if the glass transition temperature is low, compared to any known toners including a polyester resin.

(Colorant)

Specific examples of the colorants for use in the present invention include any known dyes and pigments such as carbon black, Nigrosine dyes, black iron oxide, NAPHTHOL YELLOWS, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENEBLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials can be used alone or in combination. The toner preferably includes a colorant in an amount of from 1 to 15% by weight, and more preferably from 3 to 10% by weight.

The colorant for use in the present invention can be combined with a resin to be used as a master batch. Specific examples of the resins for use in the master batch include, but are not limited to, styrene polymers and substituted styrene polymers (e.g., polystyrenes, poly-p-chlorostyrenes, polyvinyltoluenes) and copolymers thereof with vinyl compounds, polymethyl methacrylates, polybutyl methacrylates, polyvinyl chlorides, polyvinyl acetates, polyethylenes, polypropylenes, polyesters, epoxy resins, epoxy polyol resins, polyurethanes, polyamides, polyvinyl butyrals, polyacrylic acids, rosins, modified rosins, terpene resins, aliphatic or alicyclic hydrocarbon resins, aromatic petroleum resins, chlorinated paraffins, and paraffin waxes. These resins can be used alone or in combination.

(Charge Controlling Agent)

Any known charge controlling agents can be used for the toner of the present invention, and are not particularly limited. Specific examples of the charge controlling agents include, but are not limited to, Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, salicylic acid derivatives, etc. These can be used alone or in combination.

Specific examples of commercially available charge controlling agents include BONTRON® N-03 (Nigrosine dyes), BONTRON® P-51 (quaternary ammonium salt), BONTRON® S-34 (metal-containing azo dye), BONTRON® E-82 (metal complex of oxynaphthoic acid), BONTRON® E-84 (metal complex of salicylic acid), and BONTRON® E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE® PSY VP2038 (quaternary ammonium salt), COPY BLUE® PR (triphenyl methane derivative), COPY CHARGE® NEG VP2036 and COPY CHARGE® NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, a quaternary ammonium group, etc.

The content of the charge controlling agent is determined depending on the species of the binder resin used, and toner manufacturing method (such as dispersion method) used, and is not particularly limited. However, the content of the charge controlling agent is typically from 0.1 to 10 parts by weight, and preferably from 0.2 to 5 parts by weight, per 100 parts by weight of the binder resin included in the toner. When the content is too high, the toner has too large a charge quantity, and thereby the electrostatic force of a developing roller attracting the toner increases, resulting in deterioration of the fluidity of the toner and image density of the toner images.

(Release Agent)

The toner of the present invention may include a release agent. The release agent preferably has a low melting point of from 50 to 120° C. Since a release agent having a low melting point is easily separated from the binder resin, such a release agent effectively functions at an interface between a fixing roller and the toner. The resultant toner has good hot offset resistance even if used for an oilless fixing system (i.e., no oil is applied to a fixing roller).

As the release agent, waxes are preferably used.

Specific examples of the waxes include, but are not limited to, natural waxes such as plant waxes (e.g., carnauba wax, cotton wax, haze wax, rice wax), animal waxes (e.g., bees wax, lanoline), mineral waxes (e.g., ozokerite, ceresin), and petroleum waxes (e.g., paraffin, microcrystalline, petrolatum); synthetic hydrocarbon waxes such as Fischer-Tropsch wax and polyethylene wax; synthetic waxes such as esters, ketones, and ethers; fatty acid amides such as 12-hydroxystearic acid amide, stearic amide, phthalic anhydride imide, halogenated hydrocarbon; and crystalline polymers having a low molecular weight and a side-chain long alkyl group such as homopolymers or copolymers of polyacrylates such as poly-n-stearyl methacrylate and poly-n-lauryl methacrylate (e.g., copolymer of n-stearyl acrylate and ethyl methacrylate). These can be used alone or in combination.

(Modified Laminar Inorganic Mineral)

In the present invention, the modified laminar inorganic mineral is preferably added to the toner constituent mixture liquid, in which a binder resin, a prepolymer consisting essentially of a modified polyester, a compound capable of elongating or crosslinking with the prepolymer, a colorant, a release agent, etc., are dissolved or dispersed in an organic solvent, so that the toner constituent mixture liquid has a Casson yield value of from 1 to 100 Pa at 25° C. When the Casson yield value is too small, it is difficult to control the shape of the resultant toner. When the Casson yield value is too large, manufacturability of the toner deteriorates.

The Casson yield value can be determined by measuring the viscosity of the toner constituent mixture liquid which is emulsified in an aqueous medium.

The toner constituent mixture liquid preferably includes the modified laminar inorganic mineral in an amount of from 0.05 to 10% by weight on a solid basis. When the amount is too small, the toner constituent mixture liquid has too small a Casson yield value. When the amount is too large, fixability of the resultant toner deteriorates.

The modified laminar inorganic mineral for use in the present invention is a modified laminar inorganic mineral in which an interlaminar ion is partially substituted with an organic ion. For example, a laminar metal cation can be substituted with a quaternary ammonium ion. Specific examples of the modified laminar inorganic minerals include, but are not limited to, organic modified montmorillonite and organic modified smectlte.

The Casson yield value can be measured using a high shear viscometer, for example. Measuring conditions are as follows, for example.

Instrument: AR2000 (from TA Instruments Japan)

Shear stress: 120 Pa/5 min

Geometry: 40 mm steel plate

Geometry gap: 1 mm

Analysis software: TA DATA ANALYSIS (from TA Instruments Japan)

(Toner Manufacturing Method)

The toner of the present invention is preferably prepared by the following method, but the method is not limited thereto.

(1) At first, a unmodified polyester, a polyester prepolymer having an isocyanate group, a compound capable of elongating or crosslinking with the prepolymer (i.e., amine), a colorant, a release agent, and a modified laminar inorganic mineral in which an interlaminar ion is partially substituted with an organic ion are dissolved or dispersed in an organic solvent to prepare a toner constituent mixture liquid.

Volatile organic solvents having a boiling point of less than 100° C. are preferably used because such solvents can be easily removed. Specific examples of the organic solvents include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethylketone, and methyl isobutylketone. These organic solvents can be used alone or in combination. Among these, aromatic solvents such as toluene and xylene, and halogenated hydrocarbons such as methylene chloride, 1,2-dichloroethane, chloroform, and carbon tetrachloride are preferably used.

The toner constituent mixture liquid typically includes an organic solvent in an amount of from 0 to 300 parts by weight, preferably from 0 to 100 parts by weight, and more preferably from 25 to 70 parts by weight, based on 100 parts by weight of the polyester prepolymer.

(2) The thus prepared toner constituent mixture liquid is emulsified in an aqueous medium in the presence of a surfactant and a particulate resin.

Suitable aqueous media include water. In addition, other solvent which can be mixed with water can be added to water. Specific examples of such solvents include, but are not limited to, alcohols (e.g., methanol, isopropyl alcohol, ethylene glycol), dimethylformamide, tetrahydrofuran, cellosolves (e.g., methyl cellosolve), and lower ketones (e.g., acetone, methyl ethyl ketone).

The content of the aqueous medium to 100 parts by weight of the toner constituent mixture liquid is typically from 50 to 2,000 parts by weight, and preferably 100 to 1,000 parts by weight. When the content is too small, the toner constituent mixture cannot be well dispersed therein, and thereby the resultant toner hardly has the desired particle diameter. When the content is too large, the production costs increase.

When the toner constituent mixture liquid is emulsified in an aqueous medium, a surfactant and a particulate resin are added thereto as a dispersant.

Specific examples of the surfactants include, but are not limited to, anionic surfactants such as alkylbenzene sulfonic acid salts, α-olefin sulfonic acid salts and phosphoric acid salts; cationic surfactants such as amine salts (e.g., alkyl amine salts, aminoalcohol fatty acid derivatives, polyamine fatty acid derivatives, imidadoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts, benzethonium chloride); nonionic surfactants such as fatty acid amide derivatives, polyhydric alcohol derivatives; and ampholytic surfactants such as alanine, dodecyldi(aminoethyl)glycin, di(octylaminoethyl)glycin, and N-alkyl-N,N-dimethylammonium betaine.

By using a fluorine-containing surfactant as the surfactant, good charging properties and good charge rising property can be imparted to the resultant toner. Specific examples of anionic surfactants having a fluoroalkyl group include, but are not limited to, fluoroalkyl carboxylic acids having from 2 to 10 carbon atoms and metal salts thereof, disodium perfluorooctanesulfonylglutamate, sodium 3-{ω-fluoroalkyl(C6-C11)oxy}-1-alkyl(C3-C4)sulfonates, sodium 3-{ω-fluoroalkanoyl(C6-C8)-N-ethylamino}-1-propanesulfonates, fluoroalkyl(C11-C20)carboxylic acids and metal salts thereof, perfluoroalkyl(C7-C13)carboxylic acids and metal salts thereof, perfluoroalkyl(C4-C12)sulfonates and metal salts thereof, perfluorooctanesulfonic acid diethanol amides, N-propyl-N-(2-hydroxyethyl)perfluorooctanesulfone amide, perfluoroalkyl(C6-C10)sulfoneamidepropyltrimethyl ammonium salts, salts of perfluoroalkyl(C6-C10)-N-ethylsulfonylglycin, and monoperfluoroalkyl(C6-C16)ethylphosphates.

Specific examples of useable commercially available surfactants include, but are not limited to, SARFRON® S-111, S-112 and S-113, which are manufactured by Asahi Glass Co., Ltd.; FLUORAD® FC-93, FC-95, FC-98 and FC-129, which are manufactured by Sumitomo 3M Ltd.; UNIDYNE® DS-101 and DS-102, which are manufactured by Daikin Industries, Ltd.; MEGAFACE® F-110, F-120, F-113, F-191, F-812 and F-833 which are manufactured by Dainippon Ink and Chemicals, Inc.; ECTOP®EF-102, 103, 104, 105, 112, 123A, 123B, 306A, 501, 201 and 204, which are manufactured by Tochem Products Co., Ltd.; and FUTARGENT® F-100 and F-150 manufactured by Neos.

Specific examples of the cationic surfactants include, but are not limited to, primary, secondary and tertiary aliphatic amines having a fluoroalkyl group, aliphatic quaternary salts such as perfluoroalkyl(C6-C10)sulfoneamidepropyltrimethylammonium salts, benzalkonium salts, benzetonium chloride, pyridinium salts, and imidazolinium salts.

Specific examples of useable commercially available products thereof include, but are not limited to, SARFRON® S-121 (from Asahi Glass Co., Ltd.); FLUORAD® FC-135 (from Sumitomo 3M Ltd.); UNIDYNE® DS-202 (from Daikin Industries, Ltd.); MEGAFACE® F-150 and F-824 (from Dainippon Ink and Chemicals, Inc.); ECTOP® EF-132 (from Tohchem Products Co., Ltd.); and FUTARGENT® F-300 (from Neos).

The particulate resin is added to the aqueous medium so that mother toner particles are stably dispersed therein. Therefore, the particulate resin preferably covers the surfaces of the mother toner particles so that the coverage is from 10 to 90%. Specific examples of the particulate resins include, but are not limited to, particulate polymethyl methacrylates having an average particle diameter of 1 μm and 3 μm, particulate polystyrenes having an average particle diameter of 0.5 μm and 2 μm, and a particulate poly(styrene-acrylonitrile) having an average particle diameter of 1 μm. Specific examples of useable commercially available products thereof include, but are not limited to, PB-200H (from Kao Corporation), SGP and SGP-3G (from Sohken Chemical Engineering Co., Ltd.), TECHPOLYMER-SB (from Sekisui Plastics Co., Ltd.), and MICRO-PEARL (from Sekisui Chemical Co., Ltd.).

In addition, inorganic dispersants such as tricalcium phosphate, calcium carbonate, titanium oxide, colloidal silica, and hydroxyapatite can also be used.

Further, it is possible to stably disperse the toner constituent mixture liquid in an aqueous medium using a polymeric protection colloid.

Specific examples of the protection colloids include, but are not limited to, homopolymers and copolymers prepared using monomers such as acids (e.g., acrylic acid, methacrylic acid, α-cyanoacrylic acid, α-cyanomethacrylic acid, itaconic acid, crotonic acid, fumaric acid, maleic acid, maleic anhydride), (meth)acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylic acid esters, diethylene glycol monomethacrylic acid esters, glycerin monoacrylic acid esters, glycerin monomethacrylic acid esters, N-methylol acrylamide, N-methylolmeth acrylamide), vinyl alcohols and ethers thereof (e.g., vinyl methyl ether, vinyl ethyl ether, vinyl propyl ether), esters of a vinyl alcohol with a compound having a carboxyl group (e.g., vinyl acetate, vinyl propionate, vinyl butyrate), amide compounds (e.g., acrylamide, methacrylamide, diacetone acrylamide) and methylol compounds thereof, chlorides (e.g., acrylic acid chloride, methacrylic acid chloride), and monomers having a nitrogen atom or an heterocyclic ring having a nitrogen atom (e.g., vinyl pyridine, vinyl pyrrolidone, vinyl imidazole, ethylene imine); polyoxyethylene compounds (e.g., polyoxyethylene, polyoxypropylene, polyoxyethylene alkylamines, polyoxypropylene alkylamines, polyoxyethylene alkylamides, polyoxypropylene alkylamides, polyoxyethylene nonyl phenyl ethers, polyoxyethylene lauryl phenyl ethers, polyoxyethylene stearyl phenyl esters, polyoxyethylene nonyl phenyl esters); and cellulose compounds (e.g., methyl cellulose, hydroxyethyl cellulose, hydroxypropyl cellulose).

As the dispersing machine, known mixers and dispersing machines such as low shearing force type dispersing machines, high shearing force type dispersing machines, friction type dispersing machines, high pressure jet type dispersing machines, and ultrasonic dispersing machine can be used. In order to prepare a dispersion including particles having an average particle diameter of from 2 to 20 μm, high shearing force type dispersing machines are preferably used. When high shearing force type dispersing machines are used, the rotation speed of rotors is not particularly limited, but the rotation speed is generally from 1,000 to 30,000 rpm and preferably from 5,000 to 20,000 rpm. In addition, the dispersing time is also not particularly limited, but the dispersing time is generally from 0.1 to 5 minutes for batch dispersing machines. The temperature in the dispersing process is generally 0 to 150° C. (under pressure), and preferably from 40 to 98° C.

(3) The polyester prepolymer (A) having an isocyanate group is reacted with an amine (B) at the time of the emulsification.

This reaction is a crosslinking and/or an elongation reaction of polymer chains. The reaction time is determined depending on the reactivity of the isocyanate group of the polyester prepolymer (A) with the amine (B). However, the reaction time is typically from 10 minutes to 40 hours, and preferably from 2 to 24 hours. The reaction temperature is typically from 0 to 150° C., and preferably 40 to 98° C. In addition, any known catalysts such as dibutyl tin laurate and dioctyl tin laurate can be added, if desired, when the reaction is performed.

(4) After the reaction, the organic solvent is removed from the emulsion (i.e., reaction product), and the reaction product is washed and dried to get mother toner particles.

In order to prepare a spindle-shape toner particle, the emulsion is gradually heated under a laminar agitating, and then a strong shear is applied to the emulsion in a certain temperature range before removing the solvent. When a compound soluble to both acids and bases, such as calcium phosphate salts, are used as a dispersant, it is preferable that the calcium phosphate salt is dissolved by an acid such as hydrochloric acid, followed by washing with water. Enzymes are also usable to remove the dispersant.

(5) The thus prepared mother toner particles are mixed with a charge controlling agent, and the mixture is mixed with a particulate inorganic material such as silica and titanium oxide, by known methods such as using a mixer.

A toner having a small particle diameter and a narrow particle diameter distribution is easily prepared by the method mentioned above. In addition, the toner shape can be easily controlled so as to be from a spherical form to a spindle form by applying a high shear in the solvent removal process. Moreover, the toner surface condition can also be controlled so as to be smooth or rough.

As another example of the toner manufacturing method, an emulsion aggregation method is known.

In the emulsion aggregation method, a toner is prepared by subjecting particles of a resin prepared by an emulsion polymerization, a colorant, a release agent, etc., to a heteroaggregation to prepare aggregated particles, and then fusing the aggregated particles.

In particular, the emulsion aggregation method includes:

mixing dispersions of a particulate resin prepared by an emulsion polymerization, a colorant, a release agent, a modified laminar inorganic mineral in which a laminar ion is partially substituted with an organic ion, etc.;

aggregating at least particles of the particulate resin and particles of the colorant to prepare a dispersion of aggregated particles (i.e., aggregation process);

heating the dispersion of aggregated particles to fuse each of the aggregated particles with each other (i.e., fusion process).

In the aggregation process, dispersions of a particulate resin and a colorant, and optionally a release agent and a modified laminar inorganic mineral, are mixed and particles (i.e., dispersoids) of these dispersions are heteroaggregated to prepare aggregated particles. In order to stabilize the aggregated particles and to control the particle diameter and the particle diameter distribution thereof, an ionic surfactant having a different polarity to the aggregated particles or a compound having monovalent or more charge such as metal salts can be added. In the fusion process, the dispersion of the aggregated particles is heated to a temperature of not less than the glass transition temperature of the particulate resin so as to fuse the aggregated particles with each other to prepare fused particles.

Previous to the fusion process, an adhesion process can be optionally performed, in which a dispersion of a particulate material is added to the dispersion of the aggregated particles so that the particulate material uniformly adheres to the surface of the aggregated particles to prepare adhered particles (i.e., adhesion process). In particular, the dispersion of the modified laminar inorganic mineral can be added to the dispersion of the aggregated particles so that the modified laminar inorganic mineral uniformly adheres to the surface of the aggregated particles. In order that the modified laminar inorganic mineral strongly adheres to the aggregated particles, a dispersion of another particulate material can be added to the dispersion of the aggregated particles to which the modified laminar inorganic mineral is already adhered. The adhered particles are prepared by heteroaggregation, etc. The dispersion of the adhered particles is also heated to a temperature of not less than the glass transition temperature of the particulate resin so as to fuse the adhered particles with each other.

The fused particles prepared in the fusion process are present in an aqueous medium. In other words, a dispersion of the fused particles is formed. By removing the aqueous medium and impurities from the dispersion (i.e., washing process) and then drying the fused particles (i.e., drying process), toner particles can be prepared.

In the washing process, acidic or basic water is added to the dispersion of the fused particles in an amount of several times the fused particles, and then the mixture is agitated and filtered to obtain solid components. Purified water is added thereto in an amount several times the solid components, and then agitated and filtered. This operation is repeated several times until the filtrate has a pH of about 7. Thus, toner particles can be prepared. In the drying process, the toner particles are dried at a temperature of less than the glass transition temperature of the resin. A method in which dry air is circulated, and a method in which toner particles are heated in vacuum, etc., are optionally performed in the drying process.

In order to stabilize dispersions of a particulate resin, a colorant, a release agent, etc., alicyclic compounds of organic acid metal salts can be used as an emulsifier. If the stability of the dispersions of a colorant and a release agent depend on the pH and are not stable under basic conditions, or the stability of the dispersion of a particulate rein varies with time, a small amount of a surfactant can be used.

Specific examples of the surfactants include, but are not limited to, anionic surfactants (e.g., sulfates, sulfonates, phosphates, soaps), cationic surfactants (e.g., amine salts, quaternary ammonium salts), and nonionic surfactants (e.g., polyethylene glycols, ethylene oxide adducts of alkylphenols, polyols). Among these, ionic surfactants, i.e., anionic and cationic surfactants are preferably used. The anionic surfactants typically have an advantage over dispersing the particulate resin and the colorant. On the other hand, the cationic surfactants have an advantage over dispersing the release agent. The nonionic surfactants are preferably used in combination with the anionic or cationic surfactants. These surfactants can be used alone or in combination.

Specific examples of the anionic surfactants include, but are not limited to, fatty acid soaps (e.g., potassium laurate, sodium oleate, sodium salt of castor oil), sulfates (e.g., octyl sulfate, lauryl sulfate, lauryl ethersulfate, nonylphenyl ether sulfate), sulfonates (e.g., lauryl sulfonates, dodecylbenzene sulfonate, sodium salts of alkylenenaphthalene sulfonic acids such as triisopropylnaphthalene sulfonate and dibutylnaphthalene sulfonate, naphthalene sulfonate formalin condensates, monooctyl sulfosuccinate, dioctyl sulfosuccinate, lauric acid amide sulfonate, oleic acid amide sulfonate), phosphates (e.g., lauryl phosphate, isopropylphosphate, nonyl phenyl ether phosphate), dialkyl sulfosuccinates (e.g., sodium dioctyl sulfosuccinate), sulfosuccinates (e.g., disodium lauryl sulfosuccinate).

Specific examples of the cationic surfactants include, but are not limited to, amine salts (e.g., lauryl amine hydrochloride, stearyl amine hydrochloride, oleyl amine acetate, stearyl amine acetate, stearyl aminopropyl amine acetate), and quaternary ammonium salts (e.g., lauryl trimethyl ammonium chloride, dilauryl dimethyl ammonium chloride, distearyl ammonium chloride, distearyl dimethyl ammonium chloride, lauryl dihydroxyethyl methyl ammonium chloride, oleyl bispolyoxyethylene methyl ammonium chloride, lauroyl aminopropyl dimethyl ethyl ammonium sulfate, lauroyl aminopropyl dimethyl hydroxyethyl ammonium perchlorate, alkylbenzenedimethyl ammonium chloride, alkyltrimethyl ammonium chloride).

Specific examples of the nonionic surfactants include, but are not limited to, alkyl ethers (e.g., polyoxyethyleneoctyl ether, polyoxyethylene lauryl ether, polyoxyethylene stearyl ether, polyoxyethylene oleyl ether), alkyl phenyl ethers (e.g., polyoxyethylene octyl phenyl ether, polyoxyethylene nonyl phenyl ether), alkyl esters (e.g., polyoxyethylene laurate, polyoxyethylene stearate, polyoxyethylene oleate), alkylamines (e.g., polyoxyethylene lauryl aminoether, polyoxyethylene stearyl aminoether, polyoxyethylene oleyl aminoether, polyoxyethylene aminoether of soybean, polyoxyethylene aminoether of beef tallow), alkylamides (e.g., polyoxyethylene lauric acid amide, polyoxyethylene stearic acid amide, polyoxyethylene oleic acid amide), ethers of vegetable oils (e.g., polyoxyethylene ether of castor oil, polyoxyethylene ether of canola oil), alkanolamides (e.g., lauric acid dimethanol amide, stearic acid dimethanol amide, oleic acid dimethanol amide), and sorbitan ester ethers (e.g., polyoxyethylene sorbitan monolaurate, polyoxyethylene sorbitan monopalmitate, polyoxyethylene sorbitan monostearate, polyoxyethylene sorbitan monooleate).

Each of the dispersions typically includes a small amount of a surfactant so that the surfactant does not influence on the resultant toner properties. In particular, the dispersion of a particulate resin typically includes the surfactant in an amount of from 0.01 to 1% by weight, preferably 0.02 to 0.5% by weight, and more preferably from 0.1 to 0.2% by weight. When the amount is too small, aggregation tends to occur especially in a dispersion of a particulate resin which is not sufficiently basic. Each of the dispersions of a colorant and a release agent typically includes the surfactant in an amount of from 0.01 to 10% by weight, preferably 0.1 to 5% by weight, and more preferably from 0.5 to 2% by weight. When the amount is too small, each of the particles has different stability when aggregated, and therefore some particles tend to liberate. When the amount is too large, the particles tend to have a broad particle diameter distribution, and it is difficult to control the resultant particle diameter.

A toner prepared by the emulsion aggregation method may optionally include an internal additive, a charge controlling agent, a particulate inorganic material, a particulate organic material, a lubricant, an abrasive, etc., other than the resin, the colorant, and the release agent.

The internal additive is added without deteriorating chargeability of the toner. Specific examples of the internal additives include, but are not limited to, magnetic materials such as ferrites, magnetites, reduced irons, metals (e.g., cobalt, manganese, nickel), metal alloys, and compound containing a metal.

As the charge controlling agent, colorless or light-colored charge controlling agents are preferably used especially for full-color toners. Specific examples of the charge controlling agents include, but are not limited to, quaternary ammonium salt compounds, nigrosine compounds, dyes composed of complexes of aluminum, iron, chromium, etc., and triphenylmethane pigments.

Specific examples of the particulate inorganic materials include, but are not limited to, external additives used for typical toners such as silica, titania, calcium carbonate, magnesium carbonate, tricalcium phosphate, and cerium oxide. Specific examples of the particulate organic materials include, but are not limited to, external additives used for typical toners such as vinyl resins, polyester resins, and silicone resins. These particulate inorganic and organic materials can be used as a fluidizer or a cleanability improving agent. Specific examples of the lubricants include, but are not limited to, fatty acid metal salts such as ethylenebis stearic acid amide, oleic acid amide, zinc stearate, and calcium stearate. Specific examples of the abrasives include, but are not limited to, silica, alumina, and cerium oxide.

The mixture of the dispersions of a particulate resin, a modified laminar inorganic mineral, a colorant, and a release agent typically includes the colorant in an amount of not greater than 50% by weight, and preferably 2 to 40% by weight. The mixture typically includes the modified laminar inorganic mineral in an amount of from 0.05 to 10% by weight. The mixture typically includes a small amount of other components so that the components do not influence on the resultant toner properties. In particular, the mixture typically includes other components in an amount of from 0.01 to 5% by weight, and preferably from 0.5 to 2% by weight.

As the dispersion medium of the dispersions of a particulate resin, a modified laminar inorganic mineral, a colorant, and a release agent, etc., aqueous media are typically used. Specific examples of the aqueous media include, but are not limited to, waters (e.g., distilled water, ion-exchanged water) and alcohols. These can be used alone or in combination.

In the aggregation process, aggregated particles can be prepared by controlling the pH of the dispersion so as to control the emulsifying force of the emulsifier. In order to much more stably and rapidly prepare aggregated particles having much narrower particle diameter distribution, an aggregating agent can optionally be used. As the aggregating agent, compounds having a monovalent or multivalent charge are preferably used. Specific examples of such compounds include, but are not limited to, the above-mentioned water-soluble surfactants (e.g., ionic surfactants, nonionic surfactants), acids (e.g., hydrochloric acid, sulfuric acid, nitric acid, acetic acid, oxalic acid), metal salts of inorganic acids (e.g., magnesium chloride, sodium chloride, aluminum sulfate, calcium sulfate, ammonium sulfate, aluminum nitrate, silver nitrate, copper sulfate, sodium carbonate), metal salts of aliphatic and aromatic acids (e.g., sodium acetate, potassium formate, sodium oxalate, sodium phthalate, potassium salicylate), metal salts of phenols (e.g., sodium phenolate), metal salts of amino acids, and inorganic acid salts of aliphatic and aromatic amines (e.g., triethanolamine hydrochloride, aniline hydrochloride). Among these, metal salts of inorganic acids are preferably used in view of the stability of aggregated particles, the thermal and temporal stability of the aggregating agent, and the ease of washing.

The dispersion includes a small amount of the aggregating agent depending on the charge valence thereof. When the aggregating agent has monovalent charge, the dispersion includes the aggregating agent in an amount of not greater than 3% by weight. When the aggregating agent has divalent charge, the dispersion includes the aggregating agent in an amount of not greater than 1% by weight. When the aggregating agent has trivalent charge, the dispersion includes the aggregating agent in an amount of not greater than 0.5% by weight. The dispersion preferably includes the aggregating agent in an amount as small as possible. Aggregating agents having larger charge valence are preferably used because the added amount thereof can be reduced.

(Particle Diameter)

The toner of the present invention preferably has a volume average particle diameter (Dv) of from 3 to 8 μm, and the ratio (Dv/Dn) of the volume average particle diameter (Dv) to the number average particle diameter (Dn) of from 1.00 to 1.30, to reproduce microdots not less than 600 dpi. As the ratio (Dv/Dn) approaches 1, the particle diameter distribution becomes narrower. Such a toner having a small particle diameter and a narrow particle diameter distribution can be uniformly charged and transferred, and therefore high quality images without background fogging can be produced.

In particular, the toner preferably has a volume average particle diameter (Dv) of from 3 to 7 μm. Typically, a toner having a small particle diameter has an advantage in terms of producing high definition and high quality images, but has a disadvantage in terms of transferability and cleanability. When the volume average particle diameter (Dv) is too small, the toner tends to fuse on the surface of the carrier by long-term agitation in a developing device, resulting in deterioration of chargeability of a carrier, when the toner is used for a two-component developer. When the toner is used for a one-component developer, problems such that the toner forms a film on a developing roller, and the toner fuses on a toner layer forming member tend to be caused.

A toner having the ratio (Dv/Dn) of from 1.00 to 1.30 can produce high resolution and quality images. When such a toner is used for a two-component developer, an average particle diameter of toner particles included in the developer hardly changes even if a part of the toner particles are replaced with fresh toner particles, and therefore the toner has good and stable developability even after a long repeated agitation in the developing unit. When the ratio (Dv/Dn) is too large, the particle diameter of each of the toner particles varies, and thereby each of the particles independently behaves in the developing process, resulting in deterioration of microdot reproducibility. It is more preferable that the toner has the ratio (Dv/Dn) of from 1.00 to 1.20 to obtain much better quality images.

The volume average particle diameter (Dv), number average particle diameter (Dn), and particle diameter distribution of a toner can be measured using an instrument COULTER COUNTER TA-II or COULETR MULTISIZER II from Coulter Electrons Inc., for example.

The typical measuring method is as follows:

(1) 0.1 to 5 ml of a surfactant (preferably an alkylbenzene sulfonate) is included as a dispersant in 100 to 150 ml of an electrolyte (i.e., 1% NaCl aqueous solution including a first grade sodium chloride such as ISOTON-II from Coulter Electrons Inc.);

(2) 2 to 20 mg of a toner is added to the electrolyte and dispersed using an ultrasonic dispersing machine for about 1 to 3 minutes to prepare a toner suspension liquid;

(3) the volume and the number of toner particles are measured by the above instrument using an aperture of 100 μm to determine volume and number distribution thereof; and

(4) the volume average particle diameter (Dv) and the weight average particle diameter (Dn) is determined.

The channels include 13 channels as follows: from 2.00 to less than 2.52 μm; from 2.52 to less than 3.17 μm; from 3.17 to less than 4.00 μm; from 4.00 to less than 5.04 μm; from 5.04 to less than 6.35 μm; from 6.35 to less than 8.00 μm; from 8.00 to less than 10.08 μm; from 10.08 to less than 12.70 μm; from 12.70 to less than 16.00 μm; from 16.00 to less than 20.20 μm; from 20.20 to less than 25.40 μm; from 25.40 to less than 32.00 μm; and from 32.00 to less than 40.30 μm. Namely, particles having a particle diameter of from not less than 2.00 μm to less than 40.30 μm can be measured.

The toner of the present invention preferably includes toner particles having a particle diameter of not greater than 2 μm in an amount of from 1 to 10% by number, wherein the particle diameter represents a diameter of a circle having the same area of a projected image of the particle.

When the toner includes too large an amount of toner particles having a particle diameter of not greater than 2 μm, such toner particles tend to adhere to the carrier, and thereby charging stability thereof deteriorates.

The above particle diameter can be measured using a flow-type particle image analyzer FPIA-2000 (manufactured by Sysmex Corp.). The typical measurement method is as follows:

(1) 0.1 to 0.5 ml of a surfactant (preferably alkylbenzene sulfonate) is included as a dispersant in 100 to 150 ml of water from which solid impurities have been removed;

(2) 0.1 to 0.5 g of a toner is added to the electrolyte and dispersed using an ultrasonic dispersing machine for about 1 to 3 minutes to prepare a toner suspension liquid including 3,000 to 10,000 per 1 micro-liter of the toner particles; and

(3) the average particle diameter, the particle diameter distribution, the average circularity, and the circularity distribution of the toner are determined by the measuring instrument mentioned above.

(Size Factors)

The toner of the present invention may have a form similar to the spherical form. FIG. 2A is an external view of the toner, and FIGS. 2B and 2C are cross sections of the toner. The toner preferably satisfies the following relationship:
0.5≦(r2/r1)≦1.0 and 0.7≦(r3/r2)≦1.0
wherein r1, r2 and r3 represent the average major axis particle diameter, the average minor axis particle diameter, and the average thickness of particles of the toner, wherein r3≦r2≦r1.

When the ratio (r2/r1) is too small, the toner has a form far away from the spherical form, and therefore the toner has poor dot reproducibility and transferability, resulting in deterioration of the image quality. When the ratio (r3/r2) is too small, the toner has a form far away from the spherical form, and therefore the toner has poor transferability. When the ratio (r3/r2) is 1.0, the toner has a form similar to the spherical form, and therefore the toner has good fluidity.

The above-mentioned size factors (i.e., r1, r2 and r3) of toner particles can be determined as follows. At first, toner particles are uniformly dispersed and adhered to an observation surface, and then observed with a color laser microscope VK-8500 (from Keyence Corporation) at a magnification of 500 times. The major axis particle diameter, the minor axis particle diameter, and the thickness of each of a randomly selected 100 toner particles are measured and averaged to determine r1, r2, and r3 of the toner.

(External Additive)

The toner of the present invention preferably includes an external additive having an average primary particle diameter of from 50 to 500 nm and a bulk density of not less than 0.3 g/cm³. Such a toner has good cleanability. In addition, developability and transferability do not deteriorate even if the toner has a small particle diameter. For example, a silica having an average primary particle diameter of from 10 to 30 nm and a bulk density of from 0.1 to 0.2 g/cm³, which is typically used as a fluidizer, is preferably used.

When an external additive having an appropriate characteristic is present on the surface of the toner, a gap is formed between the toner and the objects such as a photoreceptor, etc. Because the external additive uniformly contacts the toner, the photoreceptor, and the charge giving member while having a small contact area, the adherence therebetween decreases, and therefore developing efficiency and transfer efficiency of the toner improves. In addition, the external additive plays a role as a roller bearing, the photoreceptor is hardly abraded and damaged. Moreover, the external additive is hardly embedded in the toner even when a high stress is applied to the photoreceptor from the cleaning blade. Even if the external additive is slightly embedded in the toner, the external additive can release and recover. Therefore, stable cleanability can be imparted to the toner for a long period of the time. Furthermore, the external additive moderately leaves from the surface of the toner and adheres to the edge of the cleaning blade, resulting in function of a dam. The dam has an effect of avoiding the phenomenon in that the toner passes through the cleaning blade. These functions of the external additive mentioned above decrease the shear applied to the toner, and thereby formation of a toner film of the photoreceptor, etc., which is caused due to low-rheological components included in the toner, in a high-speed fixation (low-energy fixation) can be prevented. In addition, an external additive having an average primary particle diameter of from 50 to 500 nm improves cleanability of the resultant toner without deteriorating fluidity thereof. Although the reason is uncertain, when a surface-treated external additive is added to the toner, the deterioration level of the developer is low even if the external additive contaminates the carrier.

The external additive typically has an average primary particle diameter of from 50 to 500 nm, and preferably from 100 to 400 nm. When the average primary particle diameter is too small, the external additive tends to be buried in the concavities of the toner surface and deteriorate the role of the roller bearing When the average primary particle diameter is too large, the defective cleaning problem occurs, in that the toner passes through the cleaning blade. This is because the external additive has a particle diameter on the order of that of the toner, and toner particles pass through the gap formed by the external additive between the cleaning blade and the photoreceptor.

The external additive preferably has a bulk density of not less than 0.3 g/cm³. When the bulk density is too small, fluidity of the toner improves, but the resultant toner and the external additive are easily scattered and the adherence thereof to the photoreceptor, etc. is increased. Therefore, the dam effect and the role of the roller bearing deteriorate.

Specific examples of particulate inorganic materials used for the external additive include, but are not limited to, SiO₂, TiO₂, Al₂O₃, MgO, CuO, ZnO, SnO₂, CeO₂, Fe₂O₃, BaO, CaO, K₂O, Na₂O, ZrO₂, CaO.SiO₂, K₂O(TiO₂)n, Al₂O₃.2SiO₂, CaCO₃, MgCO₃, BaSO₄, MgSO₄, and SrTiO₃. Among these, SiO₂, TiO₂, and Al₂O₃ are preferably used. These particulate inorganic materials may be hydrophobized by treated with a coupling agent such as hexamethylenedisilazane, dimethyldichlorosilane, and octyltrimethoxysilane.

Specific examples of particulate organic materials used for the external additive include, but are not limited to, particulate thermoplastic and thermosetting resins such as vinyl resins, polyurethane resins, epoxy resins, polyester resins, polyamide resins, polyimide resins, silicone resins, phenol resins, melamine resins, urea resins, aniline resins, ionomer resins, and polycarbonate resins. These can be used alone or in combination. In view of easily making a water dispersion of fine resin particles, vinyl resins, polyurethane resins, epoxy resins, polyester resins, and these combinations are preferably used.

Specific examples of the vinyl resins include, but are not limited to, homopolymers and copolymers of vinyl monomers such as styrene-(meth)acrylate copolymers, styrene-butadiene copolymers, (meth)acrylic acid-acrylate copolymers, styrene-acrylonitrile copolymers, styrene-maleic anhydride copolymers, and styrene-(meth)acrylic acid copolymers.

The bulk density of the external additive can be measured as follows. An external additive is gradually added to a 100 ml graduated cylinder without giving any vibration thereto. The bulk density is calculated from the following equation:
D (g/cm³)=W (g/100 ml)/100
wherein D represents a bulk density and W represents the amount of the external additive added to the 100 ml graduated cylinder.

The external additive are typically added to the toner by a method in which mother toner particles and an external additive are mechanically mixed by a known mixing device, or a method in which mother toner particles and an external additive are dispersed in a liquid using a surfactant, followed by drying, etc.

Image Forming Apparatus

The image forming apparatus of the present invention includes:

an electrostatic latent image bearing member;

an electrostatic latent image forming device configured to form an electrostatic latent image on the electrostatic latent image bearing member;

a developing device configured to develop the electrostatic latent image with a toner to form a toner image;

a transfer device configured to transfer the toner image onto a recording medium; and

a fixing device configured to fix the transferred image onto the recording medium;

and preferably includes a cleaning device and optionally includes other devices, such as a discharging device, a recycling device, and a controlling device, if desired.

(Electrostatic Latent Image Forming Device)

In the electrostatic latent image forming device, an electrostatic latent image is formed on an image bearing member. The image bearing member (i.e., photoreceptor) is not limited in material, shape, structure, size, etc., and any known image bearing members can be used. Specific examples of the materials used for the image bearing members include amorphous silicon and selenium (used for inorganic photoreceptors), polysilane and phthalopolymethine (used for organic photoreceptors), etc. Among these, amorphous silicon is preferably used with respect to the long life of the photoreceptor. The image bearing member preferably has a cylinder shape. The electrostatic latent image is formed by irradiating the charged image bearing member with a light containing image information in the electrostatic latent image forming device. The electrostatic latent image forming device preferably includes a charger configured to charge the image bearing member, and a light irradiator configured to irradiate the charged image bearing member with a light containing image information on the image bearing member.

The image bearing member is charged by applying a voltage to the surface thereof by the charger. Specific examples of the chargers include any known contact chargers including a member such as an electroconductive or semiconductive roller, a brush, a film, a rubber blade, etc., and non-contact chargers using corona discharge such as corotron and scorotron, etc.

The light irradiator irradiates the surface of the charged image bearing member with a light containing image information. Specific examples of the light irradiators include an emit optical irradiator, a rod lens array irradiator, a laser optical irradiator, a liquid crystal shutter irradiator, etc. In the present invention, the image bearing member can be irradiated from the back side thereof.

(Developing Device)

In the developing device, the electrostatic latent image is developed with the toner or the developer of the present invention to form a toner image on the image bearing member. Suitable developing devices include any known developing devices which can use the toner or the developer of the present invention, and are not particularly limited. For example, a developing device containing the toner of the present invention, and capable of directly or indirectly adhering the toner to the electrostatic latent image is preferably used. Such a developing device further including a toner container containing the toner of the present invention is more preferably used. The developing device may be either or both of a dry developing device or a wet developing device in the present invention. Moreover, the developing device may be either or both of a single-color developing device or a multi-colored developing device in the present invention. The developing device preferably includes an agitator configured to agitate the developer so as to be charged, and a rotatable magnetic roller. The toner can be used for both a two-component developer and a one-component developer.

In the developing device containing a two-component developer, the toner and the carrier are mixed and agitated. The toner is charged by the agitation, and held in a magnetic brush which is formed on the surface of a rotating magnetic roller. Because the magnetic roller is arranged near the image bearing member (photoreceptor), a part of the toner held in the magnetic brush, which is formed on the surface of the rotating magnetic roller, is moved to the surface of the image bearing member (photoreceptor) due to the electric force. Namely, the electrostatic latent image is developed with the toner to form a toner image on the image bearing member.

(Transfer Device)

In the transfer device, the toner image is transferred onto a recording medium. It is preferable that the toner image is firstly transferred onto an intermediate transfer medium, and then secondly transferred onto the recording medium. It is more preferable that the toner image is a multiple toner image which is formed with two or more full-color toners, and the multiple toner image is firstly transferred on to the intermediate transfer medium (i.e., primary transfer process), and then secondly transferred onto the recording medium (i.e., secondary transfer process).

The toner image is charged with a transfer charger and then transferred with a transfer device. The transfer device preferably includes a primary transfer device configured to transfer a toner image onto an intermediate transfer medium to form a multiple toner image, and a secondary transfer device configured to transfer the multiple toner image onto a recording medium. As the intermediate transfer medium, any known transfer media can be used. In particular, an endless transfer belt is preferably used.

The transfer device (the primary transfer device and the secondary transfer device) preferably includes a transfer device configured to attract the toner image from the image bearing member (photoreceptor) to the recording medium. The number of transfer devices can be one or more. Specific examples of the transfer devices include a corona transfer device, a transfer belt, a transfer roller, a pressure transfer roller, an adhesion transfer member, etc. Any known recording media (e.g., recoding papers) can be used as the recording media, and are not particularly limited.

(Fixing Device)

In the fixing device, the toner image transferred onto the recording medium is fixed. The toner image can be fixed every time after each toner image is transferred onto the recording medium one by one. Of course, the toner image can be fixed after all of the toner images are transferred and superimposed on the recording medium. As the fixing device, heat pressing devices are preferably used, but are not limited thereto. The heat pressing device typically includes a combination of a heat roller and a pressing roller; and a combination of a heat roller, a pressing roller, and an endless belt; etc. The heating temperature of the heat pressing device is preferably from 80 to 200° C. In the present invention, any known light fixing devices can be used in combination with the heat fixing device, or instead of the heat fixing device.

(Discharging Device)

In the discharging device, a discharging bias is applied to the electrostatic latent image bearing member so as to remove the charge therefrom. As the discharging device, any known discharging devices which can apply a discharging bias to the electrostatic latent image bearing member can be used, and is not particularly limited. For example, a discharging lamp is preferably used.

(Cleaning Device)

In the cleaning device, residual toner particles remaining on the electrostatic latent image bearing member are removed. As the cleaning device, any known cleaning devices which can remove residual toner particles from the electrostatic latent image bearing member can be used, and is not particularly limited. Specific examples of usable cleaning devices include, but are not limited to, a magnetic brush cleaner, an electrostatic brush cleaner, a magnetic roller cleaner, a blade cleaner, a web cleaner, etc. Among these, a blade cleaner is preferably used.

(Recycle Device)

In the recycling device, the toner particles removed with the cleaning device are collected and transported to the developing device. As the recycling device, any known transport device can be used, and is not particularly limited.

(Controlling Device)

In the controlling device, each image forming process is controlled. Specific examples of the controlling device include sequencers, computers, etc., but are not limited thereto.

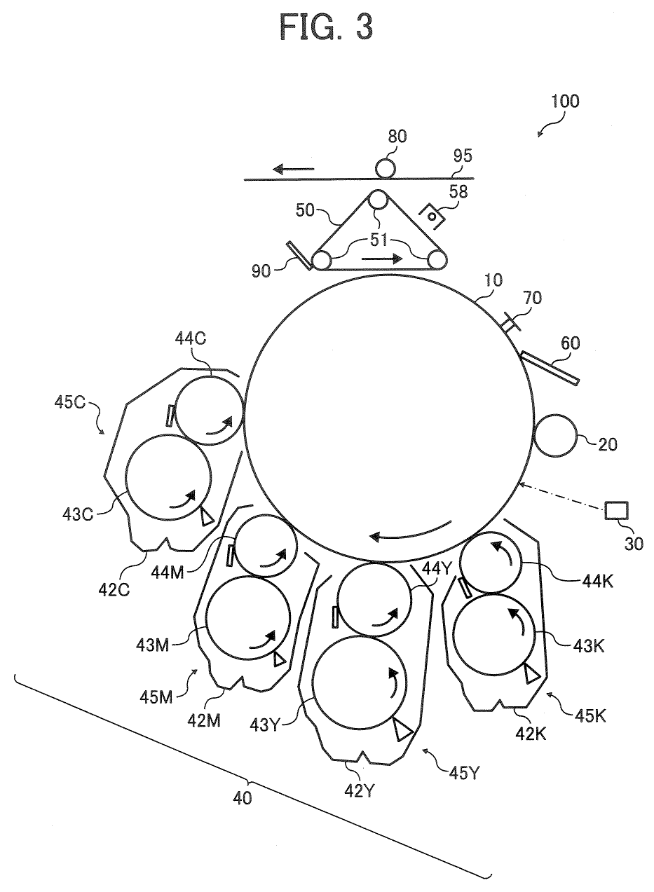

FIG. 3 is a schematic view illustrating an embodiment of the image forming apparatus of the present invention.

An image forming apparatus 100 includes a photoreceptor 10 serving as the image bearing member, a charging roller 20 serving as the charging device, a light irradiator 30 serving as the irradiating device, a developing device 40 serving as the developing device, an intermediate transfer medium 50, a cleaning device 60 including a cleaning blade serving as the cleaning device, and a discharging lamp 70 serving as the discharging device.

The intermediate transfer medium 50 is an endless belt. The intermediate transfer medium 50 is tightly stretched with three rollers 51 to move endlessly in the direction indicated by an arrow. Some of the rollers 51 have a function of applying a transfer bias (primary transfer bias) to the intermediate transfer medium 50. A cleaning device 90 including a cleaning blade is arranged close to the intermediate transfer medium 50. A transfer roller 80 is arranged facing the intermediate transfer medium 50. The transfer roller 80 can apply a transfer bias to a transfer paper 95, serving as a final transfer material, to transfer (i.e., secondary transfer) a toner image. A corona charger 58 configured to charge the toner image on the intermediate transfer medium 50 is arranged on a downstream side from a contact point of the photoreceptor 10 and the intermediate transfer medium 50, and a upstream side from a contact point of the intermediate transfer medium 50 and the transfer paper 95, relative to the rotating direction of the intermediate transfer medium 50.

The developing device 40 includes a black developing unit 45K, a yellow developing unit 45Y, a magenta developing unit 45M and a cyan developing unit 45C, arranged around the photoreceptor 10. The developing units 45K, 45Y, 45M and 45C include developer containers 42K, 42Y, 42M and 42C, developer feeding rollers 43K, 43Y, 43M and 43C, and developing rollers 44K, 44Y, 44M and 44C, respectively.

In the image forming apparatus 100, the photoreceptor 10 is uniformly charged by the charging roller 20, and then the light irradiator 30 irradiates the photoreceptor 10 with a light containing image information to form an electrostatic latent image thereon. The electrostatic latent image formed on the photoreceptor 10 is developed with a toner supplied from the developing device 40, to form a toner image. The toner image is transferred onto the intermediate transfer medium 50 due to a bias applied to a roller 51 (i.e., primary transfer), and then transferred on to the transfer paper 95 (i.e., secondary transfer) Toner particles remaining on the photoreceptor 10 are removed using the cleaning device 60, and the photoreceptor 10 is once discharged by the discharging lamp 70.

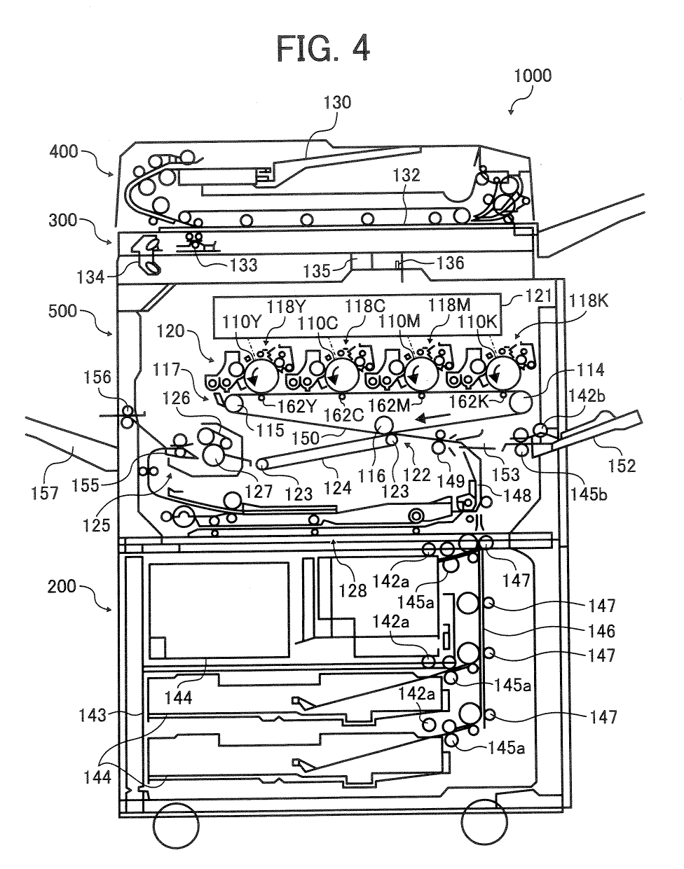

FIG. 4 is a schematic view illustrating another embodiment of the image forming apparatus of the present invention. The image forming apparatus 1000 is a tandem-type color image forming apparatus. The image forming apparatus 1000 includes a main body 500, a paper feeding table 200, a scanner 300 and an automatic document feeder (ADF) 400.

An intermediate transfer medium 150 is arranged in the center of the main body 500. The intermediate transfer medium 150, which is an endless belt, is tightly stretched with support rollers 114, 115 and 116 to rotate in a clockwise direction. A cleaning device 117, configured to remove residual toner particles remaining on the intermediate transfer medium 150, is arranged close to the support roller 115. A tandem-type image forming device 120 including image forming units 118Y, 118C, 118M and 118K is arranged facing the intermediate transfer medium 150. The image forming units 118Y, 118C, 118M and 118K are arranged in this order around the intermediate transfer medium 150 relative to the rotating direction thereof.

A light irradiator 121 is arranged close to the tandem-type image forming device 120. A secondary transfer device 122 is arranged on the opposite side of the intermediate transfer medium 150 relative to the tandem-type image forming device 120. The secondary transfer device 122 includes a secondary transfer belt 124, which is an endless belt, tightly stretched with a pair of rollers 123. A transfer paper transported on the secondary transfer belt 124 can contact the intermediate transfer medium 150. A fixing device 125 is arranged close to the secondary transfer device 122. The fixing device 125 includes a fixing belt 126 and a pressing roller 127 configured to press the fixing belt 126.

A reversing device 128 configured to reverse a transfer paper to form images on both sides of the transfer paper is arranged close to the secondary transfer device 122 and the fixing device 125.

Next, a procedure of forming a full color image with the image forming apparatus 1000 will be explained. An original document is set to a document feeder 130 included in the automatic document feeder (ADF) 400, or placed on a contact glass 132, included in the scanner 300.

When a start switch button (not shown) is pushed, the scanner 300 starts driving, and a first runner 133 and a second runner 134 start moving. When the original document is set to the document feeder 130, the scanner 300 starts driving after the original document is fed on the contact glass 132. The original document is irradiated with a light emitted by a light source via the first runner 133, and the light reflected from the original document is then reflected by a mirror included in the second runner 134. The light passes through an imaging lens 135 and is received by a reading sensor 136. Thus, image information of each color is read. Each color image information is transmitted to the image forming units 118Y, 118C, 118M and 118K, respectively, to form each color toner image.

A black toner image formed on a black photoreceptor 10K, a yellow toner image formed on a yellow photoreceptor 10Y, a magenta toner image formed on a magenta photoreceptor 10M, and a cyan toner image formed on a cyan photoreceptor 10C are independently transferred (i.e., primary transfer) onto the intermediate transfer medium 150 and superimposed thereon so that a full-color toner image is formed.

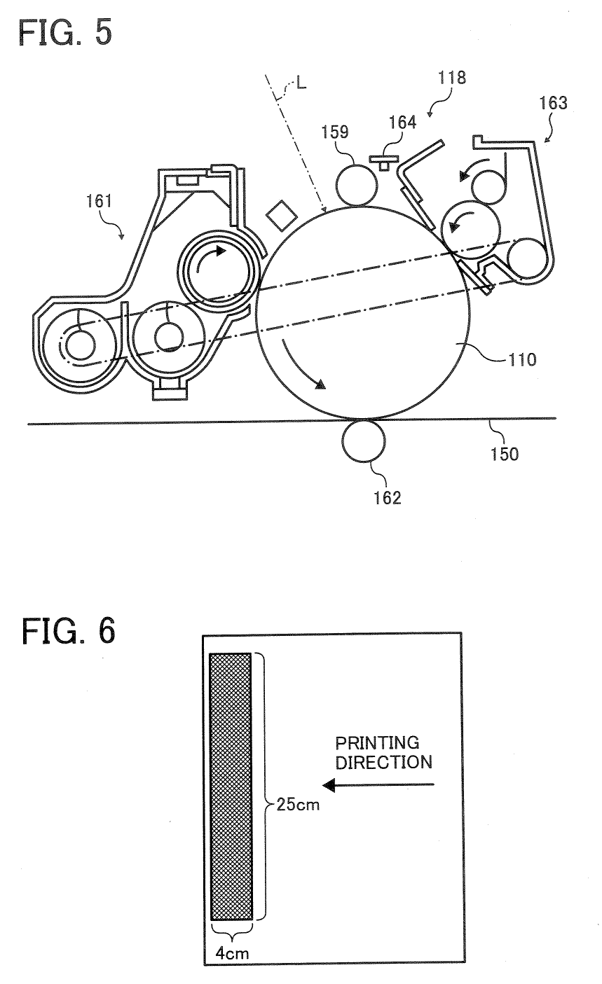

FIG. 5 is a schematic view illustrating an embodiment of the image forming units 118Y, 118C, 118M and 118K. Since the image forming units 118Y, 118C, 118M and 118K have the same configuration, only one image forming unit is illustrated in FIG. 5. Symbols Y, C, M and K, which represent each of the colors, are omitted from the reference number.

The image forming unit 118 includes a photoreceptor 110, a charger 159 configured to uniformly charge the photoreceptor 110, a light irradiator (not shown) configured to form an electrostatic latent image on the photoreceptor 110 by irradiating a light L containing image information corresponding to color information, a developing device 161 configured to form a toner image by developing the electrostatic latent image with a developer including a toner, a transfer charger 162 configured to transfer the toner image to the intermediate transfer medium 150, a cleaning device 163, and a discharging device 164.

On the other hand, in the paper feeding table 200, a recording paper is fed from one of multistage paper feeding cassettes 144, included in a paper bank 143, by rotating one of paper feeding rollers 142a. The recording paper is separated by separation rollers 145a and fed to a paper feeding path 146. Then the recording paper is transported to a paper feeding path 148, included in the main body 500, by transport rollers 147, and is stopped by a registration roller 149. When the recording paper is fed from a manual paper feeder 152 by rotating a paper feeding roller 142b, the recording paper is separated by a separation roller 145b and fed to a manual paper feeding path 153, and is stopped by the registration roller 149. The registration roller 149 is typically grounded, however, a bias can be applied thereto in order to remove a paper powder.

The recording paper is timely fed to an area formed between the intermediate transfer medium 150 and the secondary transfer device 122, by rotating the registration roller 149, to meet the full-color toner image formed on the intermediate transfer medium 150. The full-color toner image is transferred onto the recording material in the secondary transfer device 122 (secondary transfer). Toner particles remaining on the intermediate transfer medium 150 are removed with the cleaning device 17.

The recording paper having the toner image thereon is transported from the secondary transfer device 122 to the fixing device 125. The toner image is fixed on the recording paper upon application of heat and pressure thereto in the fixing device 125. The recording paper is switched by a switch pick 155 and ejected by an ejection roller 156 and then stacked on an ejection tray 157. When the recording paper is switched by the switch pick 155 to be reversed in the reverse device 128, the recording paper is fed to a transfer area again in order to form a toner image on the backside thereof. And then the recording paper is ejected by the ejection roller 156 and stacked on the ejection tray 157.

Process Cartridge

The process cartridge of the present invention includes the image bearing member, and at least one member selected from the charging device, the developing device, the cleaning device, and is detachably attached to the image forming apparatus of the present invention.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

Preparation of Unmodified Polyester

The following components were fed into a reaction vessel equipped with a condenser, a stirrer, and a nitrogen inlet pipe.

| | |
|---|---|
| Ethylene oxide (2 mole) adduct of | 229 parts |
| bisphenol A | |
| Propylene oxide (3 mole) adduct of | 529 parts |
| bisphenol A | |
| Terephthalic acid | 208 parts |
| Adipic acid | 46 parts |
| Dibutyltin oxide | 2 parts |

The mixture was reacted for 8 hours at 230° C. under normal pressure. Then the reaction was further continued for 5 hours under a reduced pressure of 10 to 15 mmHg. Then 44 parts of trimellitic anhydride were further added to the mixture, and reacted for 2 hours at 180° C. under normal pressure. Thus, an unmodified polyester (1) was prepared.

The unmodified polyester (1) had a number average molecular weight (Mn) of 2,500, a weight average molecular weight (Mw) of 6,700, a glass transition temperature (Tg) of 43° C., and an acid value of 25 mgKOH/g.

Preparation of Master Batch

The following components were mixed with a HENSCHEL MIXER (manufactured by Mitsui Mining Co., Ltd.).

| | |
|---|---|
| Water | 1200 parts |
| Carbon black | 540 parts |
| (PRINTEX 35 from Degussa AG, having DBP | |
| absorption value of 42 ml/100 mg and pH of 9.5) | |
| Unmodified polyester (1) | 1200 parts |

The mixture was kneaded for 30 minutes at 150° C. with a two-roll mill, and then subjected to rolling and cooling. The rolled mixture was pulverized using a pulverizer (manufactured by Hosokawa Micron Corporation) Thus, a master batch (1) was prepared.

Preparation of Wax Dispersion

In a reaction vessel equipped with a stirrer and a thermometer, 378 parts of the unmodified polyester (1), 110 parts of a carnauba wax, 22 parts of a metal complex of salicylic acid (BONTRON® E-84 from Orient Chemical Industries Co., Ltd.), and 947 parts of ethyl acetate were added and agitated for 5 hours at 80° C., and then cooled to 30° C. over a period of 1 hour. Further, 500 parts of the master batch (1) and 500 parts of ethyl acetate were added thereto and mixed for 1 hour. Thus, a raw material mixture liquid was prepared.

Next, 1324 parts of the raw material mixture liquid was subjected to a dispersion treatment using a bead mill (ULTRAVISCOMILL (trademark) from Aimex Co., Ltd.). The dispersing conditions were as follows.

Liquid feeding speed: 1 kg/hour

Peripheral speed of disc: 6 m/sec

Dispersion media: zirconia beads with a diameter of 0.5 mm

Filling factor of beads: 80% by volume

Repeat number of dispersing operation: 3 times (3 passes)

Thus, a wax dispersion (1) was prepared.

Preparation of Toner Constituent Mixture Liquid

At first, 1324 parts of a 65% ethyl acetate solution of the unmodified polyester (1) were added to the wax dispersion (1) The mixture was subjected to a dispersion treatment using the bead mill. The dispersion conditions are the same as those mentioned above except that the dispersion operation was performed once (i.e., one pass).

Next, 1.7 parts of a laminar inorganic mineral montmorillonite partially modified with a quaternary ammonium salt having a benzyl group (CLAYTON® APA from Southern Clay Products, Inc.) was added to 200 parts of the above mixture, and agitated for 30 minutes using a TK HOMODISPER (from Tokushu Kika Kogyo K.K.) Thus, a toner constituent mixture liquid (1) was prepared.

The toner constituent mixture liquid was subjected to a measurement of viscosity as follows. A rheometer AR2000 (from TA Instruments Japan) equipped with parallel plates having a diameter of 20 mm was adjusted to have a gap of 30 μm. The viscosity (A) was measured after a shear is applied to a sample for 30 seconds at a shear rate of 1/30,000 (l/s) and then the shear rate was changed from 0 to 1/70 (l/s) over a period of 20 seconds at 25° C. The viscosity (B) was measured after a shear is applied to a sample for 30 seconds at a shear rate of 1/30,000 (l/s) at 25° C.

Preparation of Prepolymer

The following components were fed into a reaction vessel equipped with a condenser, a stirrer, and a nitrogen inlet pipe.

| | |
|---|---|
| Ethylene oxide (2 mole) adduct of | 682 parts |
| bisphenol A | |
| Propylene oxide (2 mole) adduct of | 81 parts |
| bisphenol A | |
| Terephthalic acid | 283 parts |
| Trimellitic anhydride | 22 parts |
| Dibutyl tin oxide | 2 parts |

The mixture was reacted for 8 hours at 230° C. under normal pressure. Then the reaction was further continued for 5 hours under a reduced pressure of 10 to 15 mmHg. Thus, an intermediate polyester was prepared.

The intermediate polyester had a number average molecular weight (Mn) of 2,100, a weight average molecular weight (Mw) of 9,500, a glass transition temperature (Tg) of 55° C., an acid value of 0.5 mgKOH/g, and a hydroxyl value of 51 mgKOH/g.

In a reaction vessel equipped with a condenser, a stirrer, and a nitrogen inlet pipe, 410parts of the intermediate polyester, 89 parts of isophorone diisocyanate, and 500 parts of ethyl acetate were mixed and the mixture was heated for 5 hours at 100° C. to perform the reaction. Thus, a prepolymer (1) was prepared. The content of free isocyanate in the prepolymer was 1.53% by weight.

Synthesis of Ketimine

In a reaction vessel equipped with a stirrer and a thermometer, 170 parts of isophorone diamine and 75 parts of methyl ethyl ketone were mixed and reacted for 5 hours at 50° C. Thus, a ketimine compound was prepared. The ketimine compound had an amine value of 418 mgKOH/g.

Preparation of Oil Phase

In a reaction vessel, 749 parts of the toner constituent mixture liquid (1), 115 parts of the prepolymer (1), and 2.9 parts of the ketimine compound were added and mixed for 1 minute at a revolution of 5,000 rpm using a TK HOMOMIXER (from Tokushu Kika Kogyo K.K.). Thus, an oil phase (1) was prepared.

Preparation of Particulate Resin

In a reaction vessel equipped with a stirrer and a thermometer, 683 parts of water, 11 parts of a reactive emulsifier (a sodium salt of sulfate of an ethylene oxide adduct of methacrylic acid ELEMINOL RS-30 from Sanyo Chemical Industries Ltd.), 83 parts of styrene, 83 parts of methacrylic acid, 110 parts of butyl acrylate, and 1 part of ammonium persulfate were contained and the mixture was agitated with the stirrer for 15 minutes at a revolution of 400 rpm. As a result, a milky emulsion was prepared. Then the emulsion was heated to 75° C. to react the monomers for 5 hours. Further, 30 parts of a 1% aqueous solution of ammonium persulfate were added thereto, and the mixture was aged for 5 hours at 75° C. Thus, a particulate resin dispersion was prepared.

Preparation of Water Phase

990 parts of water, 83 parts of the particulate resin dispersion, 37 parts of a 48.5% by weight aqueous solution of a sodium salt of dodecyl diphenyl ether disulfonic acid (ELEMINOL MON-7 from Sanyo Chemical Industries Ltd.), 135 parts of a 1% by weight aqueous solution of a polymer dispersant carboxymethylcellulose sodium (CELLOGEN® BS-H-3 from Dai-ichi Kogyo Seiyaku Co., Ltd.), and 90 parts of ethyl acetate were mixed. As a result, a water phase (1) was prepared.

Emulsification or Dispersion

867 parts of the oil phase (1) were added to 1200 parts of the water phase (1). The mixture was agitated for 20 minutes at a revolution of 13,000 rpm using a TK HOMOMIXER. As a result, an emulsion slurry (1) was prepared.

Solvent Removal

The emulsion slurry (1) was fed into a reaction vessel equipped with a stirrer and a thermometer, and the emulsion slurry (1) was heated for 8 hours at 30° C. to remove the organic solvent (ethyl acetate) therefrom. Then the emulsion slurry (1) was aged for 4 hours at 45° C. Thus, a dispersion slurry (1) was prepared.

Washing and Drying

One hundred (100) parts of the dispersion slurry (1) was filtered under a reduced pressure.

The thus obtained wet cake was mixed with 100 parts of ion-exchange water and the mixture was agitated for 10 minutes with a TK HOMOMIXER at a revolution of 12,000 rpm, followed by filtering. Thus, a wet cake (i) was prepared.

The wet cake (i) was mixed with a 10% aqueous solution of hydrochloric acid so that the mixture has a pH of 2.8, and then the mixture was agitated for 10 minutes with a TK HOMOMIXER at a revolution of 12,000 rpm, followed by filtering. Thus, a wet cake (ii) was prepared.

The wet cake (ii) was mixed with 300 parts of ion-exchange water and the mixture was agitated for 10 minutes with a TK HOMOMIXER at a revolution of 12,000 rpm, followed by filtering. This washing operation was performed twice. Thus, a wet cake (iii) was prepared.

The wet cake (iii) was dried for 48 hours at 45° C. using a circulating air drier, followed by sieving with a screen having openings of 75 μm. Thus, a mother toner (1) was prepared.

External Treatment

One hundred (100) parts of the prepared mother toner (1) were mixed with 1.0 parts of a hydrophobized silica and 0.5 parts of a hydrophobized titanium oxide using a HENSHEL MIXER (manufactured by Mitsui Mining Co., Ltd.). Thus, a toner (1) was prepared.

### Example 2

The procedure for preparation of the toner in Example 1 was repeated except that the amount of the modified laminar inorganic mineral (CLAYTON® APA) was changed from 1.7 parts to 1.3 parts.

Thus, a toner (2) was prepared.

### Example 3

The procedure for preparation of the toner in Example 1 is repeated except that the amount of the modified laminar inorganic mineral (CLAYTON® APA) is changed from 1.7 parts to 1.0 part.

Thus, a toner (3) is prepared.

### Example 4

Preparation of Resin Emulsion

The following monomers are uniformly mixed to prepare a monomer mixture.

| | |
|---|---|
| Styrene | 71 parts |
| n-Butyl acrylate | 25 parts |
| Acrylic acid | 4 parts |

The following components are mixed to
prepare an aqueous mixture.

| | |
|---|---|
| Water | 100 parts |
| Nonionic emulsifier (EMULGEN 950) | 1 part |
| Anionic emulsifier (NEOGEN R) | 1.5 parts |

The aqueous mixture is added to a reaction vessel and heated to 70° C. while agitating. The monomer mixture and 5 parts of a 1% aqueous solution of potassium persulfateare simultaneously added thereto over a period of 4 hours. The mixture is subjected to the polymerization for 2 hours at 70° C. Thus, a resin emulsion having a solid content of 50% is prepared.

Preparation of Toner

The following components are mixed using TK HOMODISPER for 2 hours at 25° C.

| | |
|---|---|
| Colorant | 20 parts |
| Charge controlling agent | 1 part |
| (BONTRON ® E-84 from Orient | |
| Chemical Industries Co., Ltd.) | |
| Anionic emulsifier (NEOGEN R) | 0.5 parts |
| Water | 310 parts |

188 parts of the resin emulsion is added to the mixture and agitated for about 2 hours. The mixture is heated to 60° C., and then ammonia is added thereto so that the mixture has a pH of 7.0. The mixture is further heated to 90° C. for 2 hours. Thus, a dispersion slurry (4) is prepared.

Washing and Drying

One hundred (100) parts of the dispersion slurry (4) is filtered under a reduced pressure.

The thus obtained wet cake is mixed with 100 parts of ion-exchange water and the mixture is agitated for 10 minutes with a TK HOMOMIXER at a revolution of 12, 000 rpm, followed by filtering. Thus, a wet cake (i) is prepared.

The wet cake (i) is mixed with a 10% aqueous solution of hydrochloric acid so that the mixture has a pH of 2.8, and then the mixture is agitated for 10 minutes with a TK HOMOMIXER at a revolution of 12,000 rpm, followed by filtering. Thus, a wet cake (ii) is prepared.

The wet cake (ii) is mixed with 300 parts of ion-exchange water and the mixture is agitated for 10 minutes with a TK HOMOMIXER at a revolution of 12,000 rpm, followed by filtering. This washing operation is performed twice. Thus, a wet cake (iii) is prepared.

The wet cake (iii) is dried for 48 hours at 45° C. using a circulating air drier, followed by sieving with a screen having openings of 75 μm. Thus, a mother toner (4) is prepared.

External Treatment

One hundred (100) parts of the prepared mother toner (4) is mixed with 1.0 parts of a hydrophobized silica (R972 from Nippon Aerosil Co., Ltd., having an average primary particle diameter of 0.016 μm) Thus, a toner (4) is prepared.

### Comparative Example 1

The procedure for preparation of the toner in Example 1 was repeated except the following points:

(1) the modified laminar inorganic mineral (CLAYTON® APA) was not added to the toner constituent mixture liquid; and

(2) the emulsion slurry was heated to 30° C. to remove ethyl acetate so that the emulsion slurry includes ethyl acetate in an amount of 6% by weight, and then 100 parts of the emulsion was mixed with 0.7parts of a carboxymethylcellulose (CMC DAICEL-1280 from Daicel Chemical Industries, Ltd.) for 1 minute using an agitation paddle at a revolution of 1.8 m/s.

Thus, a comparative toner (1) was prepared.

### Comparative Example 2

The procedure for preparation of the toner in Comparative Example 1 was repeated except that the amount of the carboxymethylcellulose (CMC DAICEL-1280 from Daicel Chemical Industries, Ltd.) was changed from 0.7 parts to 1 part.

Thus, comparative toner (2) was prepared.

### Comparative Example 3

The procedure for preparation of the toner in Example 1 was repeated except that 1.7 parts of the modified laminar inorganic mineral (CLAYTON® APA) was replaced with 20 parts of ORGANOSILICASOL™ MEK-ST-UP (from Nissan Chemical Industries, Ltd., having a solid content of 20% and an average primary particle diameter of 15 nm).

Thus, comparative toner (3) was prepared.

### Comparative Example 4

The procedure for preparation of the toner in Comparative Example 3 was repeated except that the amount of the ORGANOSILICASOL™ MEK-ST-UP (from Nissan Chemical Industries, Ltd., having a solid content of 20% and an average primary particle diameter of 15 nm) was changed from 20 parts to 15 parts.

Thus, comparative toner (4) was prepared.

### Comparative Example 5

The procedure for preparation of the toner in Comparative Example 3 is repeated except that the amount of the ORGANOSILICASOL™ MEK-ST-UP (from Nissan Chemical Industries, Ltd., having a solid content of 20% and an average primary particle diameter of 15 nm) is changed from 20 parts to 10 parts.

Thus, comparative toner (5) is prepared.

### Comparative Example 6

The procedure for preparation of the toner in Example 4 is repeated except that the heating time of the mixture at 90° C. is changed from 2 hours to 5 hours.

Thus, comparative toner (6) is prepared.

Evaluation

Particle Diameter

The volume average particle diameter (Dv) and number average particle diameter (Dn) of a toner were determined using a measurement instrument COULETR MULTISIZER III (from Coulter Electrons Inc.) with an aperture having a diameter of 100 μm and an analysis software BECKMAN COULTER MULTISIZER 3 Version 3.51.

The measuring method was as follows:

(1) 0.5 ml of a 10% by weight aqueous solution of a surfactant (an alkylbenzene sulfonate NEOGEN SC-A from Dai-ichi Kogyo Seiyaku Co., Ltd.) was added to a 100 ml glass beaker;

(2) 0.5 mg of a toner was added thereto and mixed with a micro spatula, and then 80 ml of ion-exchange water was added thereto and dispersed using an ultrasonic dispersing machine (W-113MK-II from Honda Electronics) for 10 minutes to prepare a toner dispersion; and

(3) the toner dispersion was subjected to the measurement with the instrument COULETR MULTISIZER III using a measurement solution ISOTON-II (from Coulter Electrons Inc.). The toner dispersion was added so that the concentration of the toner indicated by the instrument is from 6 to 10%, in terms of improving reproducibility of the measurement.

Shape Factor SF-1

The shape factor SF-1 was determined by the following method:

(1) particles of a toner were photographed using a scanning electron microscope (FE-SEM S-4200 manufactured by Hitachi Ltd.); and

(2) photographic images of 300 randomly selected toner particles were analyzed using an image analyzer (LUZEX AP manufactured by Nicolet Corp.) to determine the SF-1.

Cleanability

The cleanability of a toner was evaluated as follows:

(1) the toners prepared above and a image forming apparatus (commercial product IMAGIO NEO C600 from Ricoh Co., Ltd.) for use in the evaluation were left in an environmental chamber of 25° C. and 50% RH for 1 day;

(2) the toner contained in the developing device of the IMAGIO NEO C600 was removed so that only the carrier was left therein;

(3) 28 g of the toner prepared above was set in the developing device containing the carrier so that 400 g of a developer including the toner in an amount of 7% by weight was prepared;

(4) the developing device was attached to the IMAGIO NEO C600, and then driven at idle for 5 minutes at a linear speed of the developing sleeve of 300 mm/s;

(5) both the developing sleeve and the photoreceptor were rotated at a linear speed of 300 mm/s so as to trail with each other, and the charged potential and the developing bias were controlled so that from 0.55 to 0.65 mg/cm² of the toner was fed on the photoreceptor;

(6) the cleaning blade of the IMAGIO NEO C600 having an elastic modulus of 70% and a thickness of 2 mm was adjusted to contact the photoreceptor so as to face in the counter direction of rotation thereof at an contact angle of 20°;

(7) the transfer current was controlled so that the transfer ratio was from 94 to 98%;

(8) a fiber tape was arranged in front of the charging roller so that toner particles passed through the cleaning blade were caught thereby;

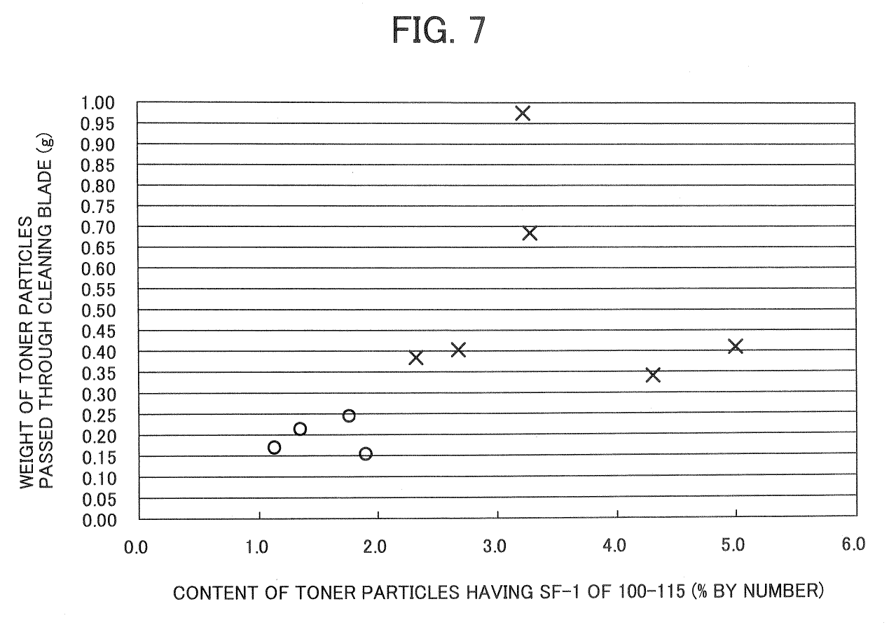

(9) 1,000 copies of a chart having a 4 cm (in the printing direction)×25 cm (in the vertical direction to the printing direction) sized image illustrated in FIG. 7 were produced; and

(10) the toner particles passed thorough the cleaning blade and caught by the fiber tape were weighed to evaluate cleanability.

When the weight of the toner particles passed through the cleaning blade is less than 0.25 g, the toner has good cleanability.

The evaluation results are shown in Table 1.

TABLE 1

| | | | | | Content of | Content of | Weight of toner |
|---|---|---|---|---|---|---|---|
| | | | | | toner | toner | particles |
| | | | | | particles | particles | passed |
| | | | | | having SF-1 | having SF-1 | through |
| | | | | | of 100-115 | of 100-120 | cleaning |
| | Dv | Dn | | Average | (% by | (% by | blade |
| | (μm) | (μm) | Dv/Dn | SF-1 | number) | number) | (g) |
| Ex. 1 | 5.2 | 4.6 | 1.13 | 142 | 1.136 | 5.681 | 0.170 |
| Ex. 2 | 5.3 | 4.7 | 1.13 | 141 | 1.754 | 4.836 | 0.243 |
| Ex. 3 | 5.1 | 4.6 | 1.11 | 140 | 1.899 | 5.267 | 0.153 |
| Ex. 4 | 5.2 | 4.6 | 1.13 | 141 | 1.346 | 5.988 | 0.213 |
| Comp. | 4.9 | 4.2 | 1.17 | 138 | 5.000 | 19.167 | 0.409 |
| Ex. 1 | | | | | | | |
| Comp. | 4.7 | 4.1 | 1.15 | 148 | 4.310 | 16.379 | 0.340 |
| Ex. 2 | | | | | | | |
| Comp. | 5.8 | 5.3 | 1.09 | 142 | 3.226 | 9.677 | 0.976 |
| Ex. 3 | | | | | | | |
| Comp. | 5.7 | 5.2 | 1.10 | 136 | 2.679 | 6.183 | 0.403 |
| Ex. 4 | | | | | | | |
| Comp. | 5.3 | 4.6 | 1.15 | 132 | 2.315 | 5.549 | 0.384 |
| Ex. 5 | | | | | | | |
| Comp. | 5.2 | 4.6 | 1.13 | 135 | 3.279 | 11.475 | 0.684 |
| Ex. 6 | | | | | | | |

FIG. 7 is a graph illustrating the relationship between the content (% by number) of toner particles having a SF-1 of from 100 to 115 and the weight (g) of toner particles passed through the cleaning blade. In FIG. 7, “o” represents a toner in which the weight of toner particles passed thorough the cleaning blade is less than 0.25 g, and “x” represents a toner 10 in which the weight of toner particles passed thorough the cleaning blade is not less than 0.25 g.

It is clear from Table 1 and FIG. 7 that a toner having an average SF-1 of from 130 to 160 and including toner particles having a SF-1 of from 100 to 115 in an amount of not greater than 2% by number has good cleanability.

This document claims priority and contains subject matter related to Japanese Patent Applications Nos. 2006-073757, filed on Mar. 17, 2006, the entire contents of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner, comprising:
a binder resin; and
a colorant,
wherein the toner has an average shape factor SF-1 of from 130 to 160, and includes toner particles having a shape factor SF-1 of from 100 to 115 in an amount of not greater than 2% by number, and
wherein the toner is prepared by a wet granulation method.

2. The toner according to claim 1, wherein the toner has an average shape factor SF-1 of from 130 to 150.

3. The toner according to claim 1, wherein the wet granulation method comprises:
dissolving or dispersing toner constituents comprising the binder resin, a prepolymer consisting essentially of a modified polyester, a compound capable of elongating or crosslinking with the prepolymer, the colorant, a release agent, and a modified laminar inorganic mineral in which an interlaminar ion is partially substituted with an organic ion, in an organic solvent to prepare a toner constituent mixture liquid;
dispersing the toner constituent mixture liquid in an aqueous medium while subjecting the prepolymer to a crosslinking or an elongation reaction with the compound, to prepare a dispersion comprising toner particles; and
removing the organic solvent from the dispersion,
wherein the toner constituent mixture has a Casson yield value of from 1 to 100 Pa at 25° C.

4. The toner according to claim 3, wherein the toner constituent mixture liquid comprises the modified laminar inorganic mineral in which an interlaminar ion is partially substituted with an organic ion in an amount of from 0.05 to 10% by weight on a solid basis.

5. The toner according to claim 1, wherein the toner has a volume average particle diameter (Dv) of from 3 to 8 μm, and a ratio (Dv/Dn) of the volume average particle diameter (Dv) to a number average particle diameter (Dn) of from 1.00 to 1.30.

6. The toner according to claim 1, wherein the toner includes toner particles having a particle diameter of not greater than 2 μm in an amount of from 1 to 10% by number,
wherein the particle diameter represents a diameter of a circle having the same area of a projected image of the particle.

7. The toner according to claim 1, further comprising an external additive having an average primary particle diameter of from 50 to 500 nm and a bulk density of not less than 0.3 g/cm³.

8. An image forming apparatus, comprising:
an image bearing member configured to bear an electrostatic latent image;
a charging device configured to charge the image bearing member;
an irradiating device configured to irradiate the charged image bearing member to form the electrostatic latent image thereon;
a developing device configured to develop the electrostatic latent image with a toner to form a toner image;
a transfer device configured to transfer the toner image onto a recording medium;
a fixing device configured to fix the toner image to the recording medium; and
a cleaning device configured to remove toner particles remaining on the image bearing member,
wherein the toner is the toner according to claim 1.

9. An image forming apparatus, comprising:
an image bearing member configured to bear an electrostatic latent image;
a charging device configured to charge the image bearing member;
an irradiating device configured to irradiate the charged image bearing member to form the electrostatic latent image thereon;
a developing device configured to develop the electrostatic latent image with a toner to form a toner image;
a transfer device configured to transfer the toner image onto a recording medium;
a fixing device configured to fix the toner image to the recording medium; and
a cleaning device configured to remove toner particles remaining on the image bearing member,
wherein the toner is the toner according to claim 2.

10. An image forming apparatus, comprising:
an image bearing member configured to bear an electrostatic latent image;
a charging device configured to charge the image bearing member;
an irradiating device configured to irradiate the charged image bearing member to form the electrostatic latent image thereon;
a developing device configured to develop the electrostatic latent image with a toner to form a toner image;
a transfer device configured to transfer the toner image onto a recording medium;
a fixing device configured to fix the toner image to the recording medium; and
a cleaning device configured to remove toner particles remaining on the image bearing member,
wherein the toner is the toner according to claim 3.

11. An image forming apparatus, comprising:
an image bearing member configured to bear an electrostatic latent image;
a charging device configured to charge the image bearing member;
an irradiating device configured to irradiate the charged image bearing member to form the electrostatic latent image thereon;
a developing device configured to develop the electrostatic latent image with a toner to form a toner image;
a transfer device configured to transfer the toner image onto a recording medium;
a fixing device configured to fix the toner image to the recording medium; and
a cleaning device configured to remove toner particles remaining on the image bearing member,
wherein the toner is the toner according to claim 4.

12. An image forming apparatus, comprising:
an image bearing member configured to bear an electrostatic latent image;
a charging device configured to charge the image bearing member;
an irradiating device configured to irradiate the charged image bearing member to form the electrostatic latent image thereon;
a developing device configured to develop the electrostatic latent image with a toner to form a toner image;
a transfer device configured to transfer the toner image onto a recording medium;
a fixing device configured to fix the toner image to the recording medium; and
a cleaning device configured to remove toner particles remaining on the image bearing member,
wherein the toner is the toner according to claim 5.

13. An image forming apparatus, comprising:
an image bearing member configured to bear an electrostatic latent image;
a charging device configured to charge the image bearing member;
an irradiating device configured to irradiate the charged image bearing member to form the electrostatic latent image thereon;
a developing device configured to develop the electrostatic latent image with a toner to form a toner image;
a transfer device configured to transfer the toner image onto a recording medium;
a fixing device configured to fix the toner image to the recording medium; and
a cleaning device configured to remove toner particles remaining on the image bearing member,
wherein the toner is the toner according to claim 6.

14. An image forming apparatus, comprising:
an image bearing member configured to bear an electrostatic latent image;
a charging device configured to charge the image bearing member;
an irradiating device configured to irradiate the charged image bearing member to form the electrostatic latent image thereon;
a developing device configured to develop the electrostatic latent image with a toner to form a toner image;
a transfer device configured to transfer the toner image onto a recording medium;
a fixing device configured to fix the toner image to the recording medium; and
a cleaning device configured to remove toner particles remaining on the image bearing member,
wherein the toner is the toner according to claim 7.

15. A process cartridge detachably attachable to an image forming apparatus, comprising:
an image bearing member configured to bear an electrostatic latent image; and
at least one member selected from a charging device configured to charge the image bearing member, a developing device configured to develop the electrostatic latent image with a toner to form a toner image, and a cleaning device configured to remove toner particles remaining on the image bearing member,
wherein the toner is the toner according to claim 1.

16. A process cartridge detachably attachable to an image forming apparatus, comprising:
an image bearing member configured to bear an electrostatic latent image; and
at least one member selected from a charging device configured to charge the image bearing member, a developing device configured to develop the electrostatic latent image with a toner to form a toner image, and a cleaning device configured to remove toner particles remaining on the image bearing member,
wherein the toner is the toner according to claim 2.

17. A process cartridge detachably attachable to an image forming apparatus, comprising:
an image bearing member configured to bear an electrostatic latent image; and
at least one member selected from a charging device configured to charge the image bearing member, a developing device configured to develop the electrostatic latent image with a toner to form a toner image, and a cleaning device configured to remove toner particles remaining on the image bearing member,
wherein the toner is the toner according to claim 3.

18. A process cartridge detachably attachable to an image forming apparatus, comprising:
an image bearing member configured to bear an electrostatic latent image; and
at least one member selected from a charging device configured to charge the image bearing member, a developing device configured to develop the electrostatic latent image with a toner to form a toner image, and a cleaning device configured to remove toner particles remaining on the image bearing member,
wherein the toner is the toner according to claim 4.

19. A process cartridge detachably attachable to an image forming apparatus, comprising:
an image bearing member configured to bear an electrostatic latent image; and
at least one member selected from a charging device configured to charge the image bearing member, a developing device configured to develop the electrostatic latent image with a toner to form a toner image, and a cleaning device configured to remove toner particles remaining on the image bearing member,
wherein the toner is the toner according to claim 5.

20. A process cartridge detachably attachable to an image forming apparatus, comprising:
an image bearing member configured to bear an electrostatic latent image; and
at least one member selected from a charging device configured to charge the image bearing member, a developing device configured to develop the electrostatic latent image with a toner to form a toner image, and a cleaning device configured to remove toner particles remaining on the image bearing member,
wherein the toner is the toner according to claim 6.

21. A process cartridge detachably attachable to an image forming apparatus, comprising:
an image bearing member configured to bear an electrostatic latent image; and
at least one member selected from a charging device configured to charge the image bearing member, a developing device configured to develop the electrostatic latent image with a toner to form a toner image, and a cleaning device configured to remove toner particles remaining on the image bearing member,
wherein the toner is the toner according to claim 7.
